(19) United States
(12) Patent Application Publication
(10) Pub. No.: US 2014/0216508 A1
(43) Pub. Date: Aug. 7, 2014

(54) SYSTEM, APPARATUS AND METHOD FOR PROCESSING SUBSTRATES USING ACOUSTIC ENERGY

(71) Applicant: Akrion Systems LLC, Allentown, PA (US)

(72) Inventor: John A. Korbler, Mertztown, PA (US)

(73) Assignee: Akrion Systems LLC, Allentown, PA (US)

(21) Appl. No.: 14/171,190

(22) Filed: Feb. 3, 2014

Related U.S. Application Data
(60) Provisional application No. 61/760,052, filed on Feb. 2, 2013.

(51) Int. Cl. B08B 3/12; B06B 1/06

(52) U.S. Cl. CPC B08B 3/123; B06B 1/0607
USPC 134/184; 310/334

(57) ABSTRACT

A system, apparatus and method for processing substrates using acoustic energy. In one aspect, the invention can be a system for processing flat articles comprising: a support supporting a flat article; a dispenser applying liquid to a first surface of the flat article; a transducer assembly comprising: a transmitting structure having a longitudinal axis; a first set of transducers acoustically coupled to the transmitting structure in a spaced apart manner on a first side of the longitudinal axis; a second set of transducers acoustically coupled to the transmitting structure in a spaced apart manner on a second side of the longitudinal axis; the transducers of the first and second sets staggered along the longitudinal axis; and wherein when the dispenser applies liquid to the first surface of the flat article, a film of liquid is formed between the transmitting structure and the first surface of the flat article.

### CROSS-REFERENCE TO RELATED APPLICATIONS

The present application claims the benefit of U.S. Provisional Patent Application Ser. No. 61/760,052, filed on Feb. 2, 2013, the entirety of which is hereby incorporated by reference.

### FIELD OF THE INVENTION

The present invention relates generally to a system, apparatus and method for generating acoustic energy for die processing of substrates, such as semiconductor wafers, raw silicon substrates, flat panel displays, solar panels, photomasks, discs, magnetic heads or any other item that requires a high level of processing precision. Specifically, the invention relates to an acoustic generating apparatus, or a system incorporating the same, or a method of processing a flat article, that can provide high levels of particle removal efficiency from flat articles containing delicate devices that minimizes damage to the delicate devices.

### BACKGROUND OF THE INVENTION

In the field of semiconductor manufacturing, it has been recognized since the beginning of the industry that removing particles from semiconductor wafers during the manufacturing process is a critical requirement to producing quality profitable wafers. While many different systems and methods have been developed over the years to remove particles from semiconductor wafers, many of these systems and methods are undesirable because they cause damage to the wafers. Thus, the removal of particles from wafers must be balanced against the amount of damage caused to the wafers by the cleaning method and/or system.

Existing techniques for freeing the particles from the surface of a semiconductor wafer utilize a combination of chemical and mechanical processes. One typical cleaning chemistry used in the art is standard clean 1 (“SC1”), which is a mixture of ammonium hydroxide, hydrogen peroxide, and water. SC1 oxidizes and etches the surface of the wafer. This etching process, known as undercutting, reduces the physical contact area to which the particle binds to the surface, thus facilitating removal. However, a mechanical process is still required to actually remove the particle from the wafer surface.

For larger particles and for larger devices, scrubbers have been used to physically brush the particle off the surface of the wafer. However, as devices have shrunk in size, scrubbers and other forms of physical cleaners have become inadequate because their physical contact with the wafers causes catastrophic damage to smaller devices.

The application of acoustic energy during wet processing has gained widespread acceptance to effectuate particle removal, especially to clean sub-micron particles off wafers (or other flat articles) undergoing fabrication in the semiconductor process line. The application of acoustic energy to substrates has proven to be a very effective way to remove particles and to improve the efficiency of other process steps, but as with any mechanical process, damage to the substrates and devices thereon is still possible. Specifically, using existing systems, the central regions of the wafer typically receive higher amounts of acoustic energy than the outer portions of the wafer due to the rotational speed of the wafer during cleaning, which affects uniformity and may damage the central regions of the wafer. Thus, acoustic cleaning of substrates is faced with the same damage issues as traditional physical cleaning. Thus, a need exists for a cleaning method, apparatus or system that can break particles free from the delicate surfaces of a semiconductor wafer without damaging the device structure and while enhancing cleaning uniformity.

### BRIEF SUMMARY OF THE INVENTION

Exemplary embodiments according to the present disclosure are directed to a system, apparatus and method of processing flat articles, such as semiconductor wafers and substrates, using acoustic energy. Such a system may include a support for supporting a flat article to be processed, a dispenser for applying liquid to a surface of the flat article, and a transducer assembly. The transducer assembly may include a transmitting structure and transducers thereon, the transducers generating acoustic energy. Various configurations of the transducers are possible to increase the particle removal from the flat article and increase uniformity of cleaning all while minimizing damage to the surfaces of the flat article.

In one aspect, the invention can be a system for processing flat articles comprising: a support for supporting a flat article; a dispenser for applying liquid to a first surface of the flat article on the support; a transducer assembly comprising: a transmitting structure having a longitudinal axis; a first set of transducers for generating acoustic energy, the first set of transducers acoustically coupled to the transmitting structure on a first side of the longitudinal axis in a spaced apart manner; a second set of transducers for generating acoustic energy, the second set of transducers acoustically coupled to the transmitting structure on a second side of the longitudinal axis in a spaced apart manner; the transducers of the first and second sets staggered along the longitudinal axis; and the transducer assembly positioned so that when the dispenser applies liquid to the first surface of the flat article on the support, a film of liquid is formed between the transmitting structure and the first surface of the flat article.

In another aspect, the invention can be an apparatus for generating acoustic energy comprising: a transmitting structure having a longitudinal axis; a first set of transducers for generating acoustic energy, the first set of transducers acoustically coupled to the transmitting structure on a first side of the longitudinal axis in a spaced apart manner; a second set of transducers for generating acoustic energy, the second set of transducers acoustically coupled to the transmitting structure on a second side of the longitudinal axis in a spaced apart manner; and the transducers of the first and second sets staggered along the longitudinal axis.

In yet another aspect, the invention can be a system for processing flat articles comprising: a support for supporting a flat article; a dispenser for applying liquid to a first surface of the flat article on the support; a transducer assembly comprising: a transmitting structure having a longitudinal axis; a first set of transducers for generating acoustic energy, the first set of transducers acoustically coupled to the transmitting structure on a first side of the longitudinal axis in a spaced apart manner; a second set of transducers for generating acoustic energy, the second set of transducers acoustically coupled to the transmitting structure on a second side of the longitudinal axis in a spaced apart manner; the first and second sets of transducers arranged in pairs along the longitudinal axis so that each transducer of the first set of transducers is transversely aligned with one of the transducers of the second set of transducers; and the transducer assembly positioned so that when the dispenser applies liquid to the first surface of the flat article on the support, a film of liquid is formed between the transmitting structure and the first surface of the flat article.

In a further aspect, the invention can be a system for processing flat articles comprising: a support for supporting a flat article; a dispenser for applying liquid to a first surface of the flat article on the support; a transducer assembly comprising a transmitting structure and a plurality of transducers for generating acoustic energy, each of the plurality of transducers acoustically coupled to the transmitting structure and being individually activatable, wherein the transducer assembly is positioned so that when the dispenser applies liquid to the first surface of the flat article on the support, a film of liquid is formed between the transmitting structure and the first surface of the flat article; an actuator operably coupled to the transducer assembly; a controller operably coupled to the actuator and configured to move the transducer assembly relative to the flat article between: (1) a first position in which each of the plurality of transducers is acoustically coupled to the film of liquid; and (2) a second position in which at least one of the plurality of transducers is acoustically decoupled from the film of liquid; and wherein in the second position the at least one of the plurality of transducers is deactivated.

In a still further aspect, the invention can be a method for processing flat articles comprising: positioning a flat article on a support and rotating the flat article; dispensing a liquid onto a first surface of the flat article; positioning a transducer assembly adjacent to the first surface of the flat article so that a film of liquid is formed between a transmitting structure of the transducer assembly and the first surface of the flat article, the transducer assembly comprising a plurality of transducers that are acoustically coupled to the transmitting structure, the plurality of transducers being individually activatable; moving the transducer assembly relative to the flat article between: (1) a first position in which each of the plurality of transducers is acoustically coupled to the film of liquid; and (2) a second position in which at least one of the plurality of transducers is acoustically decoupled from the film of liquid; and deactivating the at least one of the plurality of transducers upon the at least one of the plurality of transducers becoming acoustically decoupled from the film of liquid.

In an even further aspect, the invention can be a system for processing flat articles comprising: a support for supporting a flat article; a dispenser for applying liquid to a first surface of the flat article on the support; a transducer assembly comprising: a transmitting structure comprising a first curved surface and a second surface, the second surface opposite the first curved surface; the second surface comprising a first planar section and a second planar section, the first and second planar sections arranged at a non-zero angle relative to one another; a first transducer for generating acoustic energy, the first transducer acoustically coupled to the first planar section; and a second transducer for generating acoustic energy, the second transducer acoustically coupled to the second planar section; the transducer assembly positioned so that when the dispenser applies liquid to the first surface of the flat article on the support, a film of liquid is formed between the first curved surface of the transmitting structure and the first surface of the flat article.

In another aspect, the invention can be a system for processing flat articles comprising: a support for supporting a flat article, wherein the flat article comprises a plurality of reference rings of different radius; a dispenser for applying liquid to a first surface of the flat article on the support; a transducer assembly comprising a transmitting structure having a plurality of sections and a plurality of transducers for generating acoustic energy, at least one of the transducers acoustically coupled to each of the sections of the transmitting structure; wherein the transducer assembly is positioned so that when the dispenser applies liquid to the first surface of the flat article on the support, a film of liquid is formed between the transmitting structure and the first surface of the flat article; an actuator operably coupled to the transducer assembly; and a controller operably coupled to the actuator and configured to move the transducer assembly relative to the flat article between: (1) a first position in which at least one of the sections of the transmitting structure is positioned within each reference ring; and (2) a second position in which at least two of the sections of the transmitting structure are positioned within the reference ring having the largest radius.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic of a system for processing flat articles in accordance with a first embodiment of the present invention;

FIG. 2 is a schematic of a wafer, a dispenser and a transducer assembly of the system of FIG. 1;

FIG. 3A is a schematic overhead view of the transducer assembly and wafer of FIG. 2 in accordance with one embodiment of the present invention;

FIG. 3B is a schematic overhead view of the transducer assembly and wafer of FIG. 2 in accordance with another embodiment of the present invention;

FIG. 3C is a schematic overhead view of the transducer assembly of FIG. 2 in accordance with yet another embodiment of the present invention

FIG. 4 is a perspective view of the transducer assembly of FIG. 2;

FIG. 5 is a cross-sectional view taken along line V-V of FIG. 4;

FIG. 6A is a cross-sectional view taken along line VI-VI of FIG. 4;

FIG. 6B is an alternative structure to FIG. 6A;

FIG. 7 is a schematic representation of the transducer assembly of FIG. 2 generating acoustic energy;

FIG. 8A is a schematic overhead view of a transducer assembly and wafer in accordance with another embodiment of the present invention, wherein the transducer assembly is in a first position;

FIG. 8B is a schematic overhead view of the transducer assembly and wafer of FIG. 8A, wherein the transducer assembly is in a second position;

FIG. 9A is a schematic overhead view of a transducer assembly and wafer in accordance with yet another embodiment of the present invention, wherein the transducer assembly is in a first position;

FIG. 9B is a schematic overhead view of the transducer assembly and wafer of FIG. 9A, wherein the transducer assembly is in a second position;

FIG. 10A is a schematic overhead view of a transducer assembly and wafer in accordance with still another embodiment of the present invention, wherein the transducer assembly is in a first position;

FIG. 10B is a schematic overhead view of the transducer assembly and wafer of FIG. 10A, wherein the transducer assembly is in a second position;

FIGS. 11A-11E are various graphical representations of a power level of generated acoustic energy;

FIG. 12A is a schematic overhead view illustrating a transducer assembly and a wafer in accordance with another embodiment of the present invention, wherein the transducer assembly is in a first position; and

FIG. 12B is a schematic overhead view of the transducer assembly and wafer of FIG. 12A, wherein the transducer assembly is in a second position.

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

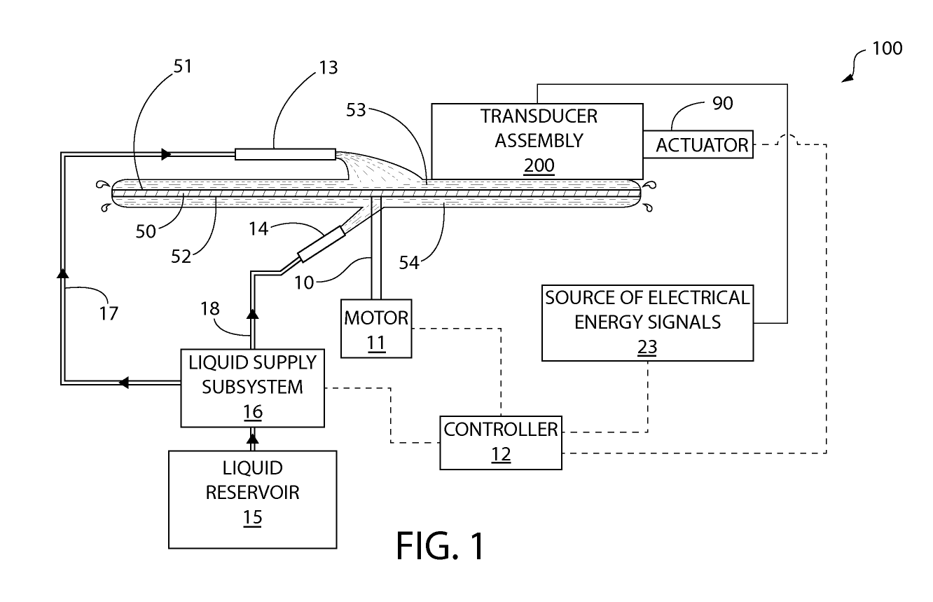

Referring first to FIG. 1, a schematic of a system for processing or cleaning flat articles 100 (hereinafter referred to as “cleaning system 100”) is illustrated according to one embodiment of the present invention. For ease of discussion the inventive system and methods of the drawings will be discussed in relation to the cleaning of semiconductor wafers. However, the invention is not so limited and can be utilized for any desired wet processing of any flat article.

The cleaning system 100 generally comprises a rotatable support 10 for supporting a semiconductor wafer 50 in a substantially horizontal orientation, a transducer assembly 200 and a dispenser 13. The exemplified embodiment also depicts a bottom dispenser 14, but the bottom dispenser 14 may be omitted in certain embodiments. Preferably, a semiconductor wafer 50 is positioned on the support 10 so that a first surface 51 (i.e., top surface) of the wafer 50 is the device side of the wafer 50 while a second surface 52 (i.e., bottom surface) of the wafer 50 is the non-device side of the wafer 50. Of course, the wafer 50 can be supported so that the top surface 51 is the non-device side while the bottom surface 52 is the device side if desired.

In the exemplified embodiment, the rotatable support 10 is designed to contact and engage only a perimeter of the substrate 50 in performing its support function. However, the exact details of the structure of the rotatable support 10 are not limiting of the present invention and a wide variety of other support structures can be used, such as chucks, support plates, etc. Additionally, while it is preferred that the support structure support and rotate the semiconductor wafer in a substantially horizontal orientation, in other embodiments of the invention, the system may be configured so that the semiconductor wafer is supported in other orientations, such as vertical or at an angle. In such embodiments, the remaining components of the cleaning system 100, including the transducer assembly 200, can be correspondingly repositioned in the system so as to be capable of performing the desired functions and/or the necessary relative positioning with respect to other components of the system as discussed below.

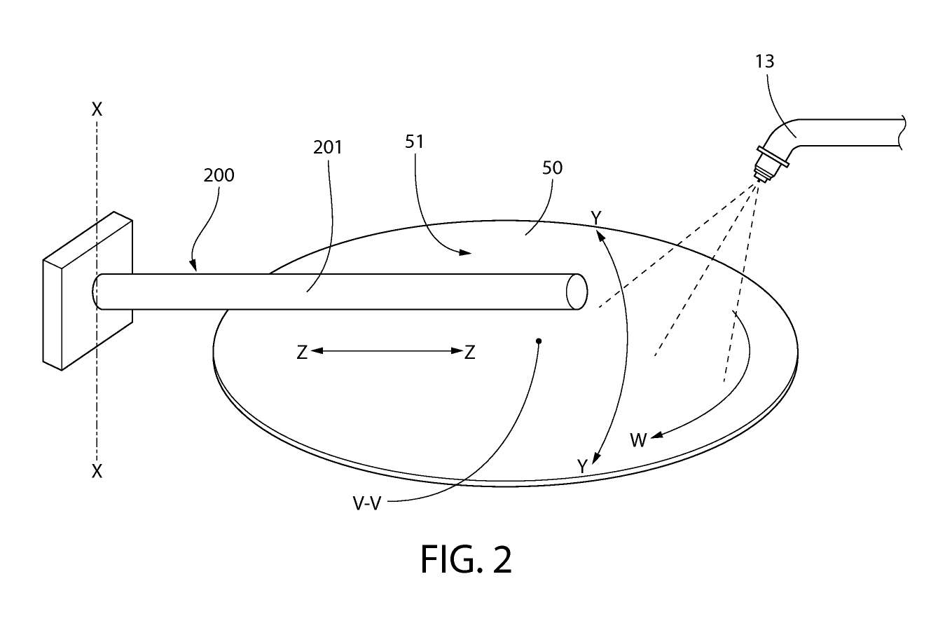

The rotary support 10 is operably coupled to a motor 11 to facilitate rotation of the wafer 50 within the horizontal plane of support in the direction of the arrow W (i.e., clockwise) or in the opposite direction (i.e., counter clockwise) about a rotational axis V-V (see FIG. 2). The motor 11 is preferably a variable speed motor that can rotate the support 10 at any desired rotational speed w. The motor 11 is electrically and operably coupled to a controller 12. The controller 12 controls the operation of the motor 11, ensuring that the desired rotational speed ω and desired duration of rotation are achieved.

As noted above, the cleaning system 100 further comprises a dispenser 13. The dispenser 13 is operably and fluidly coupled to a liquid supply subsystem 16 via a liquid supply line 17. The liquid supply subsystem 16 is in turn fluidly connected to a liquid reservoir 15. The liquid supply subsystem 16 controls the supply of liquid to the dispenser 13 and the dispenser 13 applies the liquid onto the first surface 51 (which in the exemplified embodiment is the top surface) of the wafer 50.

The liquid supply subsystem 16, which is schematically illustrated as a box for purposes of simplicity, comprises the desired arrangement of all of the necessary pumps, valves, ducts, connectors and sensors for controlling the flow and transmission of the liquid throughout the cleaning system 100. The direction of the liquid flow is represented by the arrows on the supply line 17. Those skilled in the art will recognize that the existence, placement and functioning of the various components of the liquid supply subsystem 16 will vary depending upon the needs of the cleaning system 100 and the processes desired to be carried out thereon, and can be adjusted accordingly. The components of the liquid supply subsystem 16 are operably connected to and controlled by the controller 12.

The liquid reservoir 15 holds the desired liquid to be supplied to the wafer 50 for the processing that is to be carried out. For the cleaning system 100, the liquid reservoir 15 will hold a cleaning liquid, such as for example deionized water (“DIW”), standard clean 1 (“SC1”), standard clean 2 (“SC2”), ozonated deionized water (“DIO₃”), dilute or ultra-dilute chemicals, any other liquid that is commonly used for semiconductor wafer cleaning and/or combinations thereof. As used herein, the term “liquid” includes at least liquids, liquid-liquid mixtures and liquid-gas mixtures. It is also possible for certain other supercritical and/or dense fluids to qualify as liquids in certain situations. In certain embodiments it may be possible to have multiple liquid reservoirs. For example, in some embodiments of the invention, the top dispenser 13 can be operably and fluidly coupled to several different liquid reservoirs. This would allow the application of different liquids to the first surface 51 of the wafer 50 if desired. In other embodiments the top dispenser 13 may be coupled to one liquid reservoir while the bottom dispenser 14 is coupled to a different liquid reservoir so that a different liquid is applied to the first (or top) surface 51 of the wafer 50 than to the second (or bottom) surface 52 of the wafer.

The cleaning system 100 further comprises an actuator 90 that is operably coupled to the transducer assembly 200. The actuator 90 is operably coupled to and controlled by the controller 12. The actuator 90 can be a pneumatic actuator, a drive-assembly actuator, or any other style desired to effectuate the necessary movement. The actuator 90 can translate the transducer assembly 200 between a first position and a second position and any position therebetween. In certain embodiments, discussed in more detail below, the actuator 90 may move the transducer assembly 200 in a linear direction. In other embodiments, also discussed in more detail below, the actuator 90 may move the transducer assembly 200 in an arcuate or rotational direction. The movement of the transducer assembly 200 may be similar to that of the tone arm of a vintage record player. Specifically, one end of the transducer assembly 200 may be held non-movably in place and form a pivot point (or rotational axis) and the other end of the transducer assembly 200 may be capable of rotating about the pivot point.

In certain embodiments, the cleaning system 100 also comprises an electrical energy signal source 23 that is operably coupled to the transducer assembly 200. The electrical energy signal source 23 creates the electrical signal that is transmitted to a transducer of the transducer assembly 200 for conversion into corresponding acoustic energy. Specifically, in certain embodiments transducers, which may be formed of a piezoelectric material such as a ceramic or crystal, form a part of the transducer assembly 200. In such embodiments, the transducer is coupled to the source of electrical energy 23. An electrical energy signal (i.e. electricity) is supplied to the transducer from the source of electrical energy 23. The transducer converts this electrical energy signal into vibrational mechanical energy (i.e. acoustic energy) which is then transmitted to the substrates being processed.

The transmission of the acoustic energy from the transducer to the substrates is typically accomplished through a liquid that is positioned between the transducer assembly 200 and the wafer 50 and that therefore acoustically couples the transducer to the substrate (discussed in more detail below). In certain embodiments, a material capable of acoustic energy transmission may be positioned between the transducer and the fluid coupling layer to avoid shorting of the electrical contacts on the piezoelectric material. This transmitting material (referred to herein as a transmitting structure in certain instances) can take on a wide variety of structural arrangements, including a thin layer, a rigid plate, a rod-like probe, a lens, etc. The transmitting material is usually produced of a material that is inert with respect to the fluid coupling layer to avoid contamination of the substrate. The details of the components of the transducer assembly, including the transducers and the transmitting structure, will be discussed in more detail below.

The electrical energy signal source 23 is operably coupled to and controlled by the controller 12. As a result, the controller 12 will dictate the activation status, frequency, power level, and duration of the acoustic energy generated by the transducer assembly 200. In certain embodiments, the electrical energy signal source 23 is controlled so that the acoustic energy generated by the transducer assembly 200 has a frequency in the megasonic range. Depending on system requirements, it may not be desirable to use a single electrical energy signal source to control all of the transducers of the transducer assembly 200. Thus, in other embodiments of the invention, multiple electrical energy signal sources may be used, one for each transducer of the transducer assembly 200.

The controller 12 may be a processor, which can be a suitable microprocessor based programmable logic controller, personal computer, or the like for process control. The controller 12 preferably includes various input/output ports used to provide connections to the various components of the cleaning system 100 that need to be controlled and/or communicated with. The electrical and/or communication connections are indicated in dotted line in FIG. 1. The controller 12 also preferably comprises sufficient memory to store process recipes and other data, such as thresholds inputted by an operator, processing times, rotational speeds, processing conditions, processing temperatures, flow rates, desired concentrations, sequence operations, and the like. The controller 12 can communicate with the various components of the cleaning system 100 to automatically adjust process conditions, such as flow rates, rotational speed, movement of the components of the cleaning system 100, etc. as necessary. The type of system controller used for any given system will depend on the exact needs of the system in which it is incorporated.

The dispenser 13 is positioned and oriented so that when a liquid is flowed therethough, the liquid is applied to the first surface 51 of the wafer 50. When the wafer 50 is rotating, this liquid forms a layer or film of the liquid 53 across the entirety of the first surface 51 of the wafer 50. Similarly, in the exemplified embodiment the bottom dispenser 14, which may be omitted in other embodiments, is positioned and oriented so that when a liquid is flowed therethough, the liquid is applied to the second surface 52 of the substrate 50. When the substrate 50 is rotating, this liquid forms a layer or film of the liquid 54 across the entirety of the second surface 52 of the substrate 50. Furthermore, due to the positioning of the transducer assembly 200 adjacent the first surface 51 of the wafer 50, the film of liquid 53 is formed between the transducer assembly 200 and the first surface 51 of the wafer 50. More specifically, the transducer assembly 200 is positioned so that a small gap exists between a portion of the transducer assembly 200 and the first surface 51 of the wafer 50. This gap is sufficiently small so that when the liquid is applied to the first surface 51 of the wafer 50, a meniscus of liquid is formed between the first surface 51 of the wafer 50 and the portion of the transducer assembly 200. The meniscus is not limited to any specific shape.

As will be noted, the transducer assembly 200 is generically illustrated as a box. This is done because, in its broadest sense, the invention is not limited to any particular structure, shape and/or assembly arrangement for the transducer assembly 200. For example, any of the transducer assemblies disclosed in U.S. Pat. No. 6,039,059, issued Mar. 21, 2000, U.S. Pat. No. 7,145,286, issued Dec. 5, 2006, U.S. Pat. No. 6,539,952, issued Apr. 1, 2003, and United States Patent Application Publication 2006/0278253, published Dec. 14, 2006, can be used as the transducer assembly 200. Of course, other styles of transducer assemblies can also be used, such as those having an elongated transmitter rod supported at an angle to the surface of the wafer or the like.

Referring now to FIG. 2, a schematic representation of the wafer 50, the dispenser 13 and the transducer assembly 200 is provided in accordance with one embodiment of the present invention. These components may be formed as a part of a processing structure or bowl. Specifically, the transducer assembly 200 may be movably (or nonmovably) coupled to the processing structure or bowl and the wafer may be positioned within the processing structure or bowl. An example of such a processing structure or bowl is illustrated and described in U.S. Pat. No. 7,784,478, issued on Aug. 31, 2010, the entirety of which is incorporated herein by reference.

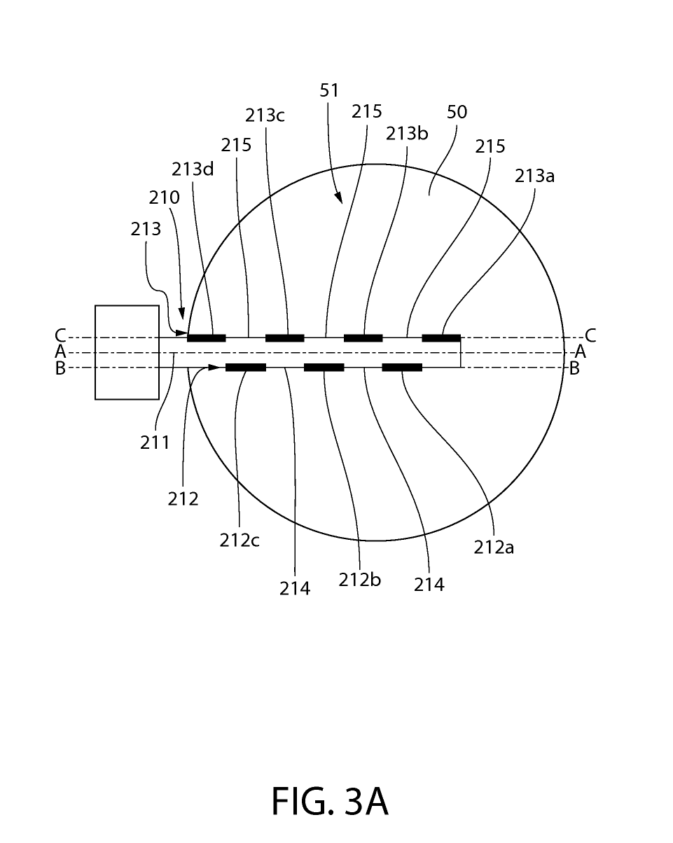

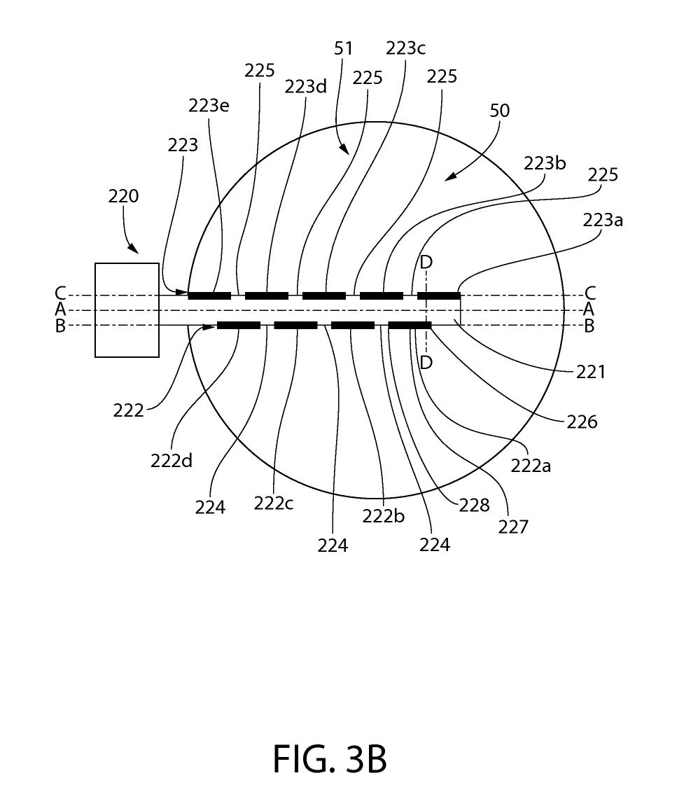

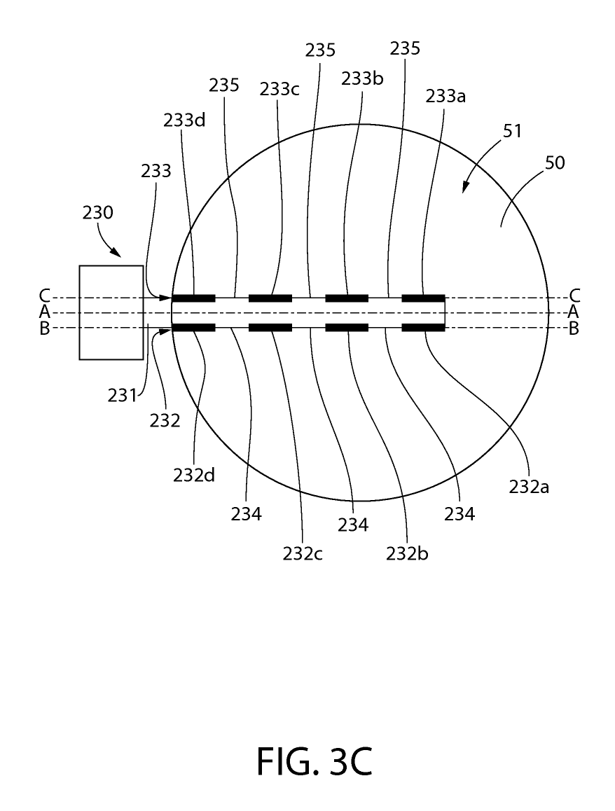

The transducer assembly 200 comprises a transmitting structure 201 and a plurality of transducers (not illustrated in FIG. 2, but described in detail below with reference to FIGS. 3A-3C). In certain embodiments, the transmitting structure 201 may be a hollow structure and the transducers may be located within the interior of the transmitting structure 201. The transmitting structure 201, in the exemplified embodiment, is an elongated rod-like probe that is positioned over top of the first surface 51 of the wafer 50 in a cantilevered manner.

As discussed in more detail below, the transmitting structure 201 may in some embodiments be movable in a linear or rotational/arcuate manner relative to the first surface 51 of the wafer 50. Specifically, an end of the transducer assembly 200 that is not positioned over the wafer 50 may form a rotational axis X-X about which the transmitting structure 201 may move in a rotational manner (as indicated by the arrows Y-Y). Alternatively the entire transducer assembly 200 may move in a linear manner back and forth across the wafer 50 (as indicated by the arrows Z-Z). Furthermore, in the exemplified embodiment the transmitting structure 201 extends across the wafer 50 a distance that is slightly greater than the radius of the wafer 50. However, the invention is not to be so limited and in certain other embodiments the transmitting structure 201 may extend across the entire diameter of the wafer 50, or the transmitting structure 201 may extend exactly to the center-point of the wafer 50, or the transmitting structure 201 may extend slightly less than the radius of the wafer 50. Thus, the exact length of the transmitting structure 201 relative to the wafer 50 is not to be limiting in all embodiments. However, it is preferable that the transmitting structure 201 be capable of applying acoustic energy to the entirety of the surface of the first surface 51 wafer 50.

As illustrated in the schematic of FIG. 2, the dispenser 13 dispenses the liquid onto the first surface 51 of the wafer 50. Furthermore, the wafer 50 is made to rotate as indicated by the directional arrow W. Although the directional arrow indicates that the wafer 50 rotates in a clockwise direction, the invention is not to be so limited and the wafer 50 can also rotate in a counter-clockwise direction if so desired. While the dispenser 13 applies the liquid to the first surface 51 of the wafer 50, the transmitting structure 201 is positioned close to the first surface 51 of the wafer 50 so that the film of liquid (see element 53, FIG. 1) that forms on the first surface 51 of the wafer 50 is positioned between the transmitting structure 201 and the wafer 50.

As noted above, in the exemplified embodiment the transmitting structure 201 is an elongated rod-like probe that is tubular in shape and has a hollow interior cavity. However, the invention is not to be so limited and it should be appreciated that the transmitting structure 201 can take on any other desired shape such as being a flat plate, triangular shaped, diamond shaped, other polygonal shaped or the like. The transmitting structure 201 need not be hollow in all embodiments. Specifically, in embodiments whereby the transmitting structure 201 is hollow, the transducers may be located within the hollow interior of the transmitting structure 201. In embodiments whereby the transmitting structure 201 is a solid structure, the transducers may be coupled to a top surface, a bottom surface or side surfaces of the transmitting structure 201. The transmitting structure 201 can be constructed of any material that transmits acoustic energy generated by the transducers into and through the film of liquid, including without limitation polymers, quartz, sapphire, boron nitride, vitreous carbide, plastic, and metals. Suitable metals may include aluminum and stainless steel. Of course, any other material that can effectively transmit acoustic energy to facilitate the intended semiconductor wafer processing may also be used.

Referring now to FIG. 3A, one embodiment of a transducer assembly 210 is illustrated in accordance with an embodiment of the invention. In FIG. 3A, the transducer assembly 210 is positioned the same as in FIGS. 1 and 2 described above relative to the wafer 50 so that as liquid is applied to the wafer 50, a film of the liquid is formed between the transducer assembly 210 and the first surface 51 of the wafer 50. The transducer assembly 210 generally comprises a transmitting structure 211, a first set of transducers 212 and a second set of transducers 213. Each transducer 212a-c of the first set of transducers 212 and each transducer 213a-d of the second set of transducers 213 is configured to generate acoustic energy. Specifically, each transducer 212a-c, 213a-d may be coupled to the source of electrical energy signals 23 so that the transducers 212a-c, 213a-d can convert electrical energy signals into vibrational mechanical energy (i.e. acoustic energy) which is then transmitted to the wafer 50 being processed.

Although in the exemplified embodiment the first set of transducers 212 includes three transducers 212a-c and the second set of transducers 213 includes four transducers 213a-d, the invention is not to be so limited in all embodiments. Rather, any number of transducers may be included in each of the first and second sets of transducers 212, 213 as desired. The transducers 212a-c, 213a-d are acoustically coupled to the transmitting structure 211. This can be accomplished through a direct bonding of the transducers 212a-c, 213a-d to the transmitting structure 211 or an indirect bonding that utilizes intermediary transmission layers. As noted above, the transducers 212a-c, 213a-d are operably coupled to the source of electrical energy signals 23. In certain embodiments, each transducer 212a-c, 213a-d may be operably coupled to a different source of electrical energy signals so that each transducer may be separately controllable with respect to power level and activation status (or this can be accomplished by the controller even using a single source of electrical energy signals). Thus, in certain embodiments each transducer may be individually activatable. As noted above, the transducers 212a-c, 213a-d can be a piezoelectric ceramic or crystal or any other device capable of generating acoustic energy as discussed herein.

In the exemplified embodiment, the transmitting structure 211 is an elongated probe-like structure that extends along a longitudinal axis A-A. As discussed above, the transmitting structure 211 need not be probe-like in shape in all embodiments and can take on other forms. The first set of transducers 212 are acoustically coupled to the transmitting structure 211 on a first side of the longitudinal axis A-A. Although not required in all embodiments, in the exemplified embodiment the first set of transducers 212 are aligned along a first axis B-B that is substantially parallel to the longitudinal axis A-A. In some embodiments, the first set of transducers 212 may be aligned along an axis that is non-parallel relative to the longitudinal axis A-A. The second set of transducers 213 are acoustically coupled to the transmitting structure on a second side of the longitudinal axis A-A, the second side of the longitudinal axis A-A being opposite the first side of the longitudinal axis A-A. Although not required in all embodiments, in the exemplified embodiment the second set of transducers 213 are aligned along a second axis C-C that is substantially parallel to the longitudinal axis A-A. In some embodiments, the second set of transducers 213 may be aligned along an axis that is non-parallel relative to the longitudinal axis A-A.

In the exemplified embodiment, the transducers 212a-c of the first set of transducers 212 are acoustically coupled to the transmitting structure 211 in a spaced apart manner. Thus, a first transducer 212a of the first set of transducers 212 is spaced apart from a second transducer 212b of the first set of transducers 212 by a gap 214 and the second transducer 212b of the first set of transducers 212 is spaced apart from a third transducer 212c of the first set of transducers 212 by a gap 214. The gaps 214 may be deemed longitudinal gaps because adjacent transducers 212a-c of the first set of transducers 212 are spaced apart in the longitudinal direction (i.e., in the direction of the longitudinal axis A-A or more specifically in the direction of the longitudinal axis B-B).

Similarly, in the exemplified embodiment, the transducers 213a-d of the second set of transducers 213 are acoustically coupled to the transmitting structure 211 in a spaced apart manner. Thus, a first transducer 213a of the second set of transducers 213 is spaced apart from a second transducer 213b of the second set of transducers 213 by a gap 215, the second transducer 213b of the second set of transducers 213 is spaced apart from a third transducer 213c of the second set of transducers 213 by a gap 215, and the third transducer 213c of the second set of transducers 213 is spaced apart from a fourth transducer 213d of the second set of transducers 213 by a gap 215. The gaps 215 may be deemed longitudinal gaps because adjacent transducers 213a-d of the second set of transducers 213 are spaced apart in the longitudinal direction (i.e., in the direction of the longitudinal axis A-A or more specifically in the direction of the longitudinal axis C-C).

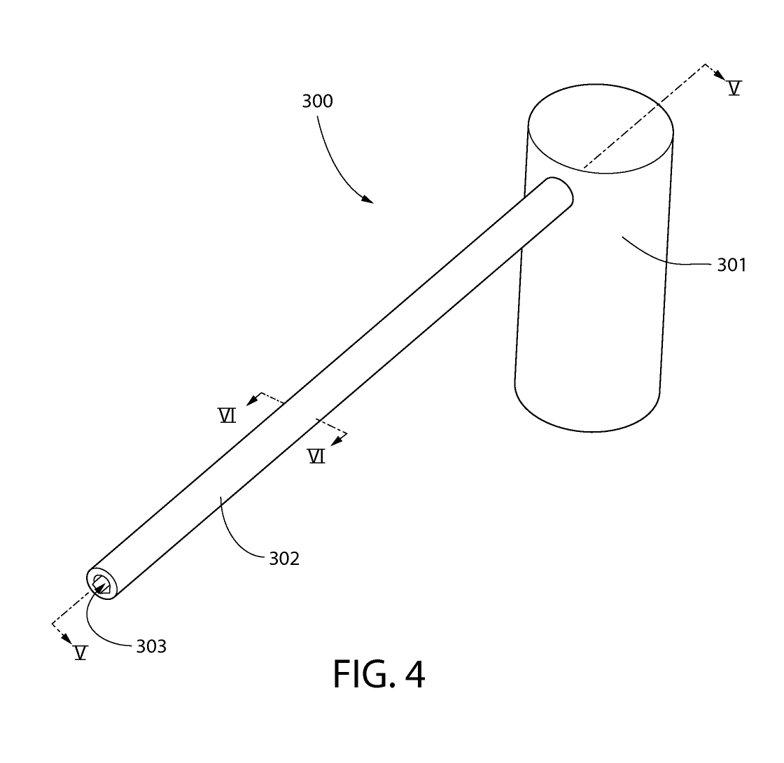

In certain embodiments, each of the transducers 212a-c, 213a-d is individually activatable and adjustable from a power level standpoint. In this regard, each of the transducers 212a-c, 213a-d may be separately coupled to a source of electrical energy signals (or to separate sources of electrical energy signals) and to the controller 12. Furthermore, as will be discussed in more detail below with reference to FIGS. 4-7, in certain embodiments each of the transducers 212a-c, 213a-d is oriented within the transmitting structure 211 so that the acoustic energy generated by each transducer 212a-c, 213a-d contacts the wafer 50 at a non-normal and preferably acute angle. Specifically, the transducers 212a-c of the first set of transducers 212 may transmit the acoustic energy in a first direction away from the longitudinal axis A-A and the transducers 212a-d of the second set of transducers 213 may transmit the acoustic energy in a second direction away from the longitudinal axis A-A, the first and second directions being opposite one another.

Transmitting the acoustic energy at a non-normal angle relative to the wafer 50 prevents reflected acoustic waves (waves that bounce off of the wafer 50 and travel in a direction away from the wafer 50) from contacting the transducer assembly 210. Rather, reflected acoustic waves will travel away from the transducer assembly 210 which can prevent the reflected acoustic waves from interfering with the generated acoustic waves. Reflected waves can cause heat build-up and damage to the transducers, which is undesirable. Furthermore, transmitting the acoustic energy at an angle also prevents standing waves between the transducer and the wafer surface, which can cause high energy points and damage to the wafer. Of course, the invention is not to be so limited in all embodiments and in certain other embodiments one or more of the transducers (and in some cases all of the transducers) may be oriented so as to transmit the acoustic energy at a normal angle relative to the wafer 50.

In the embodiment exemplified in FIG. 3A, the transducers 212a-c of the first set of transducers 212 and the transducers 213a-d of the second set of transducers 213 are staggered or offset relative to one another along the longitudinal axis A-A (or, stated another way, are staggered in the direction of the longitudinal axis A-A). What this means is that no transducer 212a-c (and no portion thereof) of the first set of transducers 212 is transversely aligned with a transducer 213a-d (or portion thereof) of the second set of transducers 213 and vice versa. Stated another way, there is no plane that is transverse to the longitudinal axis A-A that intersects one of the transducers 212a-c of the first set of transducers 212 and one of the transducers 213a-d of the second set of transducers 213. Rather, each transducer 212a-c of the first set of transducers 212 is transversely aligned with one of the gaps 215 between adjacent transducers 213a-d of the second set of transducers 213 and each transducer 213a-d of the second set of transducers 213 is transversely aligned with one of the gaps 214 between adjacent transducers 212a-c of the first set of transducers 212. In other words, in the embodiment exemplified in FIG. 3A, there is no overlap between the transducers 212a-c of the first set of transducers 212 and the transducers 213a-d of the second set of transducers 213.

Referring now to FIG. 3B, another embodiment of a transducer assembly 220 is illustrated in accordance with an embodiment of the present invention. The transducer assembly 220 is similar to the transducer assembly 210 depicted in FIG. 3A with some minor differences. Thus, it will be appreciated that certain aspects of the transducer assembly 220 will not be repeated herein below in the interest of brevity, it being understood that the description of the similar feature from the transducer assembly 210 applies. The same numbering will be used for the same features except that numbers in the 220s will be used to describe the features of FIG. 3B whereas numbers in the 210s were used to describe the features of FIG. 3A.

In FIG. 3B, the transducer assembly 220 is positioned the same as in FIG. 3A described above relative to the wafer 50 so that as liquid is applied to the wafer 50, a film of the liquid is formed between the transducer assembly 220 and the first surface 51 of the wafer 50. Specifically, the transducer assembly 220 is positioned in a cantilevered manner such that the transducer assembly 220 is fixed at one end (the end that is not over top of the wafer 50) and free at the opposite end (the terminal end that is unattached and positioned over top of the wafer 50). The transducer assembly 220 generally comprises a transmitting structure 221, a first set of transducers 222 and a second set of transducers 223. In the exemplified embodiment, the first set of transducers 222 includes four separate and distinct transducers 222a-d and the second set of transducers 223 includes five separate and distinct transducers 223a-e, although the invention is not to be limited by the exact number of transducers in each set in all embodiments. Each transducer 222a-d of the first set of transducers 222 and each transducer 223a-e of the second set of transducers 223 is configured to generate acoustic energy. Specifically, each transducer 222a-d, 223a-e may be coupled to the source of electrical energy signals 23 so that the transducers 222a-d, 223a-e can convert electrical energy signals into vibrational mechanical energy (i.e. acoustic energy) which is then transmitted to the wafer 50 being processed.

The first set of transducers 222 are acoustically coupled to the transmitting structure 221 in a spaced apart manner on a first side of the longitudinal axis A-A of the transmitting structure 221. Although not required in all embodiments, in the exemplified embodiment the first set of transducers 222 are aligned along a first axis B-B that is substantially parallel to the longitudinal axis A-A. In other embodiments the first set of transducers 222 may be aligned along an axis that is non-parallel to the longitudinal axis A-A. The second set of transducers 223 are acoustically coupled to the transmitting structure 221 in a spaced apart manner on a second side of the longitudinal axis A-A of the transmitting structure 221. Although not required in all embodiments, in the exemplified embodiment the second set of transducers 223 are aligned along a second axis C-C that is substantially parallel to the longitudinal axis A-A. The second set of transducers 223 may be aligned along a longitudinal axis that is non-parallel to the longitudinal axis A-A.

As with the embodiment of FIG. 3A, the transducers of the first and second sets of transducers 222, 223 are staggered along the longitudinal axis A-A. However, in this embodiment there is some overlap between the transducers of the first and second sets of transducers 222, 223. Thus, in this embodiment a plane that is transverse to the longitudinal axis A-A (such as plane D-D in FIG. 3B) intersects at least one transducer (such as transducer 222a) of the first set of transducers 222 and at least one transducer (such as transducer 223a) of the second set of transducers 223. In fact, for each transducer 222a-d of the first set of transducers 222, there is a plane transverse to the longitudinal axis that intersects that transducer 222a-d of the first set of transducers 222 and at least one transducer 223a-e of the second set of transducers 223 and vice versa. This can be advantageous in ensuring a more uniform coverage of the first surface 51 of the wafer 50 with the acoustic energy during processing. Specifically, in certain embodiments the transducers 222a-d, 223a-e may emit a greater strength acoustic energy wave from a central region along the length of the transducer 222a-d, 223a-e than from the edges thereof. Thus, by having overlap there will be redundant acoustic energy waves contacting the first surface 51 of the wafer 50 at the areas in which the acoustic energy waves are lower strength.

To further describe the relationship between the transducers 222a-d of the first set of transducers 222 and the transducers 223a-e of the second set of transducers 223, the following is noted. Adjacent transducers of the first set of transducers 222 are separated by a gap 224 and adjacent transducers of the second set of transducers 223 are separated by a gap 225. Each transducer 222a-d of the first set of transducers 222 is transversely aligned with one of the gaps 225 between adjacent transducers 223a-e of the second set of transducers 223 and with a portion of at least one transducer 223a-e of the second set of transducers 223. Each transducer 223a-e of the second set of transducers 223 is transversely aligned with one of the gaps 224 between adjacent transducers 222a-d of the first set of transducers 222 and with a portion of at least one transducer 222a-d of the first set of transducers 222.

Stated another way and discussed and illustrated in particular with reference to a first transducer 222a of the first set of transducers 222, the first transducer 222a of the first set of transducers 222 has a first section 226, a second section 227 and a third section 228. The second section 227 is located between the first section 226 and the third section 228 and forms a central region or section of the transducer 222a. The first section 226 of the first transducer 222a of the first set of transducers 222 is transversely aligned with a first transducer 223a of the second set of transducers 223. The third section 228 of the first transducer 222a of the first set of transducers 222 is transversely aligned with a second transducer 223b of the second set of transducers 223. The second section 227 of the first transducer 222a of the first set of transducers 222 is transversely aligned with the gap 225 between the first and second transducers 223a, 223b of the second set of transducers 223. Although discussed above with regard to the first transducer 222a only, this first section, second section and third section discussion and the relative positional relationship is applicable to each transducer of the first and second sets of transducers 222, 223.

Referring now to FIG. 3C, another embodiment of a transducer assembly 230 is illustrated in accordance with an embodiment of the present invention. The transducer assembly 220 is similar to the transducer assemblies 210, 220 depicted in FIGS. 3A and 3B with some minor differences. Thus, it will be appreciated that certain aspects of the transducer assembly 230 will not be repeated herein in the interest of brevity, it being understood that the description of the similar feature from the transducer assemblies 210, 220 applies. The same numbering will be used for the same features except that numbers in the 230s will be used to describe the features of FIG. 3C whereas numbers in the 210s were used to describe the features of FIG. 3A and numbers in the 220s were used to describe the features of FIG. 3B.

In FIG. 3C, the transducer assembly 220 is positioned the same as in FIGS. 3A and 3B described above relative to the wafer 50 so that as liquid is applied to the wafer 50, a film of the liquid is formed between the transducer assembly 230 and the first surface 51 of the wafer 50. The transducer assembly 230 generally comprises a transmitting structure 231, a first set of transducers 232 and a second set of transducers 233. In the exemplified embodiment, the first set of transducers 232 includes four separate and distinct transducers 232a-d and the second set of transducers 233 includes four separate and distinct transducers 233a-d, although the invention is not to be limited by the exact number of transducers in each set in all embodiments. Each transducer 232a-d of the first set of transducers 232 and each transducer 233a-d of the second set of transducers 233 is configured to generate acoustic energy. Specifically, each transducer 232a-d, 233a-d may be coupled to the source of electrical energy signals 23 so that the transducers 232a-3d, 233a-d can convert electrical energy signals into vibrational mechanical energy (i.e. acoustic energy) which is then transmitted to the wafer 50 being processed.

The first set of transducers 232 are acoustically coupled to the transmitting structure 231 in a spaced apart manner on a first side of the longitudinal axis A-A of the transmitting structure 231. Although not required in all embodiments, in the exemplified embodiment the first set of transducers 232 are aligned along a first axis B-B that is substantially parallel to the longitudinal axis A-A. The first set of transducers 232 may also be aligned along an axis that is non-parallel to the longitudinal axis A-A in other embodiments. The second set of transducers 233 are acoustically coupled to the transmitting structure 231 in a spaced apart manner on a second side of the longitudinal axis A-A of the transmitting structure 231. Although not required in all embodiments, in the exemplified embodiment the second set of transducers 233 are aligned along a second axis C-C that is substantially parallel to the longitudinal axis A-A. In other embodiments, the second set of transducers 233 may be aligned along a longitudinal axis that is non-parallel to the longitudinal axis A-A.

Differently from the embodiments of FIGS. 3A and 3B, in FIG. 3C the first and second sets of transducers 232, 233 are aligned rather than staggered. Thus, the first and second sets of transducers 232, 233 are aligned in pairs along the longitudinal axis so that the first transducer 232a of the first set of transducers 232 is transversely aligned with the first transducer 233 of the second set of transducers 233, the second transducer 232b of the first set of transducers 232 is transversely aligned with the second transducer 233b of the second set of transducers 233, and so on. Similarly, the gaps 234 between adjacent transducers of the first set of transducers 232 are transversely aligned with the gaps 235 between adjacent transducers of the second set of transducers 233. Thus, the embodiment of FIG. 3C provides an alternative arrangement to the staggering of the transducers of the various sets by arranging the transducers of the various sets in aligned pairs.

In certain embodiments FIG. 3C may be modified so that adjacent transducers are positioned end-to-end with no gap between adjacent transducers. Thus, a plurality of distinct transducers may be coupled to the transmitting structure 231 on opposing sides of the longitudinal axis A-A, but they may be coupled close to each other either so that the ends of adjacent transducers are in contact or so that a very small space (in the order of approximately 0.1 mm to 3 mm, 0.1 mm to 2 mm, or 0.1 mm to 1 mm) is left between adjacent transducers.

Regardless of which particular structural arrangement is used for the transducers (such as that depicted in FIGS. 3A, 3B, 3C or otherwise), when multiple transducers are used, uniformity should be considered. Specifically, the wafer rotates beneath the transducer assembly while the acoustic energy is being applied to the surface of the wafer. Central regions of the wafer travel slower than regions of the wafer near the edges, and so accommodations should be made to ensure that the central regions of the wafer do not receive too much acoustic energy that may cause damage to those regions of the wafer. Accommodations should also be made to ensure that the edges of the wafer receive enough acoustic energy to ensure adequate particle removal.

In this regard, in one embodiment the transducers that are located at the central regions of the wafer can be operated at a lower power level than the transducers that are located at the edges of the wafer. The goal for each area would be to have the same or substantially the same average energy/area/unit time for each area or region of the wafer (including the central region of the wafer and the edge regions of the wafer). In another embodiment, the transducers at the central regions of the wafer can run for a short time and then be deactivated (powered off), and then successive transducers from center of the wafer to the edge of the wafer can be deactivated one or more at a time. In another alternative embodiment, a transmitter having multiple transducers along its length can be moved away from the center of the wafer toward and off of the edge of the wafer. This will enable the edge of the wafer to receive extended acoustical energy to increase uniformity. As transducers leave the edge of the wafer, they can be turned off or deactivated to prolong the life cycle thereof and prevent burnout, which will be discussed in more detail below.

Referring to FIGS. 4-7 concurrently, a transducer assembly 300 will be described in accordance with an embodiment of the present invention. The transducer assembly 300 is similar in terms of the arrangement of the transducers to the embodiment of FIG. 3A. However, as discussed in more detail below, the invention is not to be so limited and the transducer arrangement can be similar to that of FIG. 3B, 3C or any other arrangement desired in other embodiments. In other words, the structural details described herein with regard to FIGS. 4-7 are applicable to each of the embodiments of FIGS. 3A-3C and to other embodiments not specifically described herein.

The transducer assembly 300 generally comprises a base 301, a transmitting structure 302, and a plurality of transducers arranged as a first set of transducers 312 and a second set of transducers 313. In this embodiment, the transmitting structure 302 is a generally elongated tube-shaped structure extending from the base 301 of the transducer assembly 300 in a cantilevered manner. Thus, the transmitting structure 302 is a hollow tubular structure that defines an interior cavity 303. The various transducers are coupled to the transmitting structure 302 within the interior cavity 303 as will be discussed in more detail below.

In the exemplified embodiment, the first and second sets of transducers 312, 313 are arranged in rows in a similar manner to that which was described with reference to FIG. 3A. However, the invention is not to be so limited and the first and second sets of transducers 312, 313 can be arranged in the manner depicted in FIG. 3B or in the manner depicted in FIG. 3C if so desired or in any other manner. FIGS. 4-7 merely illustrates one particular embodiment of the transducer assembly 300, it being understood that any of the other embodiments described herein (and some not disclosed herein) can also be used.

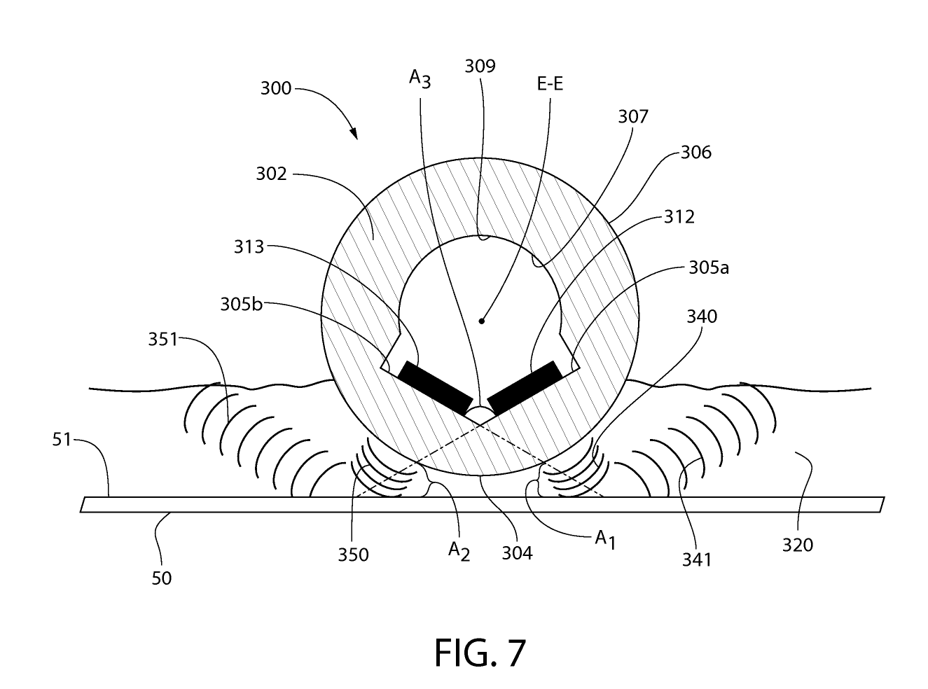

In the embodiment exemplified in FIGS. 4, 5, 6A and 7, the transmitting structure 302 comprises a first curved surface 304 and a second surface 305, the second surface being opposite the first curved surface 304. In the exemplified embodiment, the transmitting structure 302 has a tubular shape having an outer surface 306 and an inner surface 307. Thus, in the exemplified embodiment the first curved surface 304 forms a bottom portion of the outer surface 306 of the transmitting structure 302. The second surface 305 of the transmitting structure 302 comprises a first planar section 305a and a second planar section 305b. The first and second planar sections 305a, 305b are arranged at a non-zero angle A₃ relative to one another. In the exemplified embodiment, the non-zero angle is between approximately 90° and 140°, more specifically between approximately 110° and 130°, and still more specifically between approximately 120° and 130°. In another embodiment the angle A₃ is between approximately 115° and 125° or approximately 120°. These angle ranges are preferable in certain embodiments in order to ensure that the reflected acoustic wave does not cause interference with the generated acoustic wave, discussed in more detail below with specific reference to FIG. 7. Of course, other angles can be used as the non-zero angle A₃ if desired, such as a substantially 90° angle or an angle that is acute and less than 90°.

The first and second planar sections 305a, 305b of the second surface 305 of the transmitting structure 302 form a floor of the interior cavity 303 of the transmitting structure 302. As can be appreciated from viewing FIG. 7, each of the first and second planar sections 305a, 305b of the second surface 305 of the transmitting structure 302 is angled relative to the first surface 51 of the wafer 50 that the transmitting structure 302 is fluidly coupled to. This will be discussed in more detail below with the reference to FIG. 7.

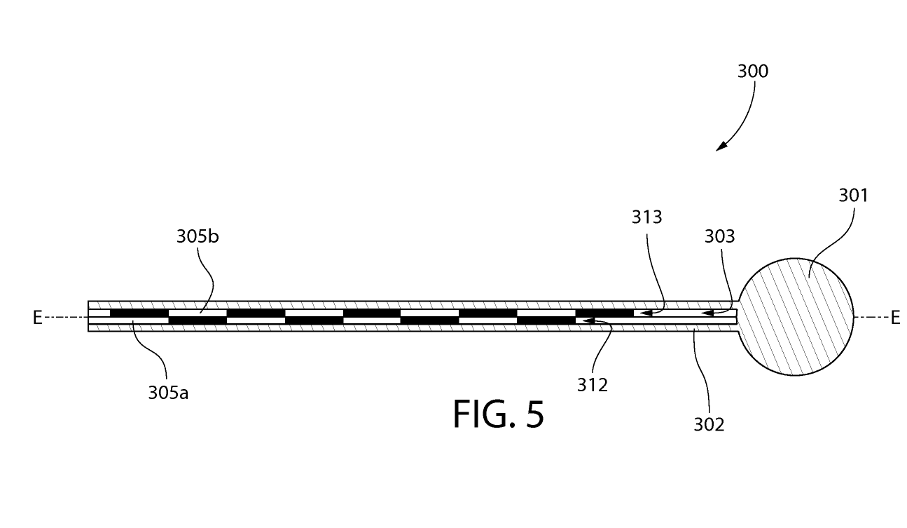

The first and second planar sections 305a, 305b of the second surface 305 of the transmitting structure 302 intersect or converge at a bottom-most portion 308 of the interior cavity 303 of the transmitting structure 302. Furthermore, each of the first and second planar sections 305a, 305b is slanted upwardly as it extends away from the bottom-most portion 308 of the interior cavity 303 of the transmitting structure 302. Thus, the first and second planar sections 305a, 305b collectively form a “V” shape (the second surface 305 of the transmitting structure 302 is V-shaped). A first transducer 312a is acoustically coupled to the first planar section 305a and a second transducer 313a is acoustically coupled to the second planar section 305b. Of course, in the exemplified embodiment several transducers (i.e., a first set of transducers 312) are coupled to the first planar section 305a and several transducers (i.e., a second set of transducers 313) are coupled to the second planar section 305b (see FIG. 5).

In the exemplified embodiment, a top portion 309 of the inner surface 307 of the transmitting structure 302 is a concave surface. Of course, the invention is not to be so limited and the top portion 309 of the inner surface 307 of the transmitting structure 302 can take on any other shape or contour as desired. Furthermore, in the exemplified embodiment a sidewall 310 extends upwardly from each of the first and second planar sections 305a, 305b to the top portion 309. In the exemplified embodiment, the sidewall 310 extends approximately perpendicularly from the first and second planar sections 305a, 305b. Thus, although the outer surface 306 of the transmitting structure 302 is cylindrical in nature in this embodiment, the inner surface 307 is not.

The shape of the inner surface 307 of the transmitting structure 302 is specifically designed so that acoustic energy generated by the transducers 312, 313 will contact the surface of the wafer at an angle so that acoustic waves that are reflected back from the wafer will travel away from the transducer assembly 300. Furthermore, as depicted, in certain embodiments each of the transducers 312, 313 has a flat planar bottom surface. Thus, the inventive transmitting structure 302 enables the transducers 312, 313 to emit acoustic energy to the wafer at an angle relative to the wafer surface without the transducers 312, 313 having a curved bottom surface. This facilitates ease of manufacture of the transducers 312, 313 while still achieving the goal of preventing reflected acoustic waves from interfering with the generated acoustic waves.

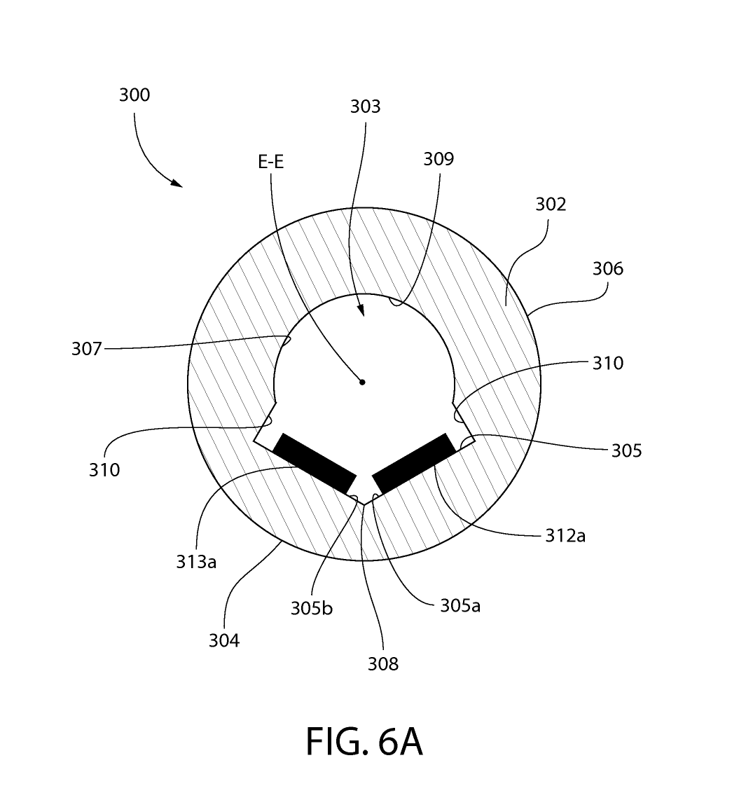

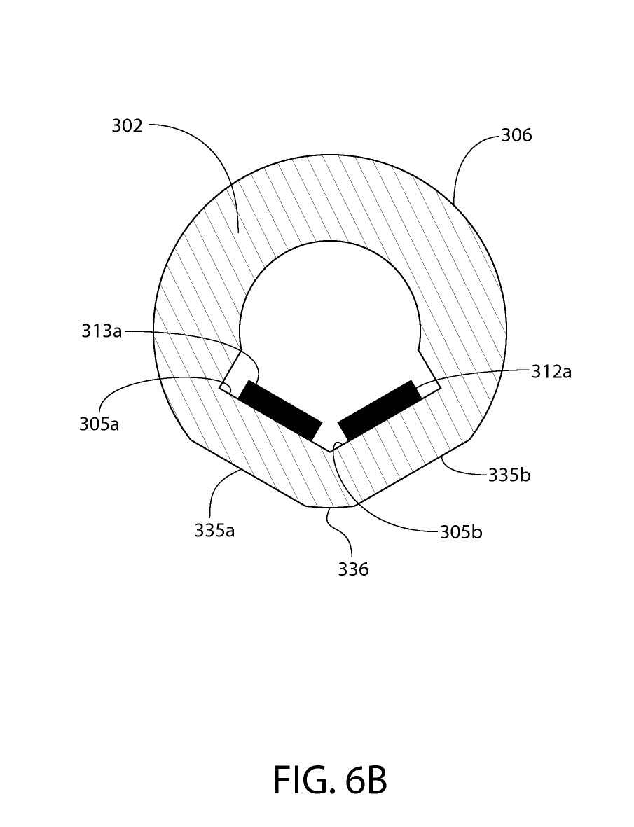

The above-described structure is depicted in FIGS. 4, 6A and 7. FIG. 6B illustrates one alternative structure whereby the first curved surface is replaced with flat surfaces 335a, 335b. Specifically, in FIG. 6B the portions of the outer surface 306 that are opposite the planar surfaces 305a, 305b to which the transducers 312a, 313a are coupled are also flat, planar surfaces 335a, 335b. Thus, FIG. 6B is identical to FIG. 6A with the exception that the bottom portion of the outer surface 306 of the transmitting structure 302 has two flat surfaces 335a, 335b that are slanted in opposing directions. In the embodiment exemplified in FIG. 6B, the two flat surfaces 335a, 335b on the bottom portion of the outer surface 306 of the transmitting structure 302 are parallel to the respective opposing planar surfaces 305a, 305b to which the transducers are coupled. The two flat surfaces 335a, 335b may be connected together by a short curved section 336 of the outer surface 306 of the transmitting structure 302 as illustrated or by a straight flat section of the outer surface 306 of the transmitting structure 302.

Referring to FIG. 5, the transmitting structure 302 extends along a longitudinal axis E-E. Furthermore, each of the first and second planar sections 305a, 305b are longitudinally elongated sections positioned on opposing sides of the longitudinal axis E-E. In the embodiment exemplified in FIG. 5, the first set of transducers 312 are acoustically coupled to the first planar section 305a in a spaced apart manner and the second set of transducers 313 are acoustically coupled to the second planar section 305b in a spaced apart manner. Furthermore, as noted above, in this embodiment the first and second sets of transducers 312, 313 are staggered along the longitudinal axis E-E. However, the invention is not to be so limited and in certain other embodiments the first and second sets of transducers 312, 313 may be positioned in pairs that are transversely aligned along the longitudinal axis E-E or otherwise as desired.

Referring now to FIG. 7, the transmitting structure 302 is illustrated positioned adjacent to the wafer 50 such that a film of liquid 320 is formed between the first curved surface 304 of the transmitting structure 302 and the first (i.e., top) surface 51 of the wafer 50. The first planar section 305a is angled at an angle A₁ relative to the first surface 51 of the flat article 50. The second planar section 305b is angled at an angle A₂ relative to the first surface 51 of the flat article 50. In certain embodiments, each of the angles A₁, A₂ is an acute angle. In the exemplified embodiment, each of the angles A₁, A₂ is between 20° and 40°, more specifically between 25° and 35°, and still more specifically approximately 30°. Of course, other angles can be used. However, the angles noted above may be preferable to ensure that reflected waves do not interfere with generated waves, discussed in more detail below.

The first transducer (or the first set of transducers 312) is configured to generate acoustic energy 340 at a first non-normal angle relative to the first surface 51 of the wafer 50. As can be seen, as the acoustic energy 340 contacts the first surface 51 of the wafer 50, reflected acoustic waves 341 bounce off of the first surface 51 of the wafer 50. Due to the angled orientation of the first transducer 312, the reflected acoustic waves 341 travel away from and do not come into contact with the transmitting structure 302 or any other portion of the transducer assembly 300. The acoustic energy 340 generated by the first transducer 312 is transmitted towards the first surface 51 of the wafer 50 on a first side of the longitudinal axis E-E of the transmitting structure 302. More specifically, the acoustic energy 340 contacts the first surface 51 of the wafer 50 on the same side of the longitudinal axis E-E as the first transducer 312 is positioned.

Similarly, the second transducer (or the second set of transducers 313) is configured to generate acoustic energy 350 at a second non-normal angle relative to the first surface 51 of the wafer 50. In the exemplified embodiment, the second non-normal angle is substantially the same as the first non-normal angle. However, the invention is not to be so limited and the first and second non-normal angles can be different from one another in other embodiments. As can be seen, as the acoustic energy 350 contacts the first surface 51 of the wafer 50, reflected acoustic waves 351 bounce off of the first surface 51 of the wafer 50. Due to the angled orientation of the second transducer 313, the reflected acoustic waves 351 travel away from and do not come into contact with the transmitting structure 302 or any other portion of the transducer assembly 300. The acoustic energy 350 generated by the second transducer 313 is transmitted towards the first surface 51 of the wafer 50 on a second side of the longitudinal axis E-E of the transmitting structure 302. More specifically, the acoustic energy 350 contacts the first surface 51 of the wafer 50 on the same side of the longitudinal axis E-E as the second transducer 313 is positioned. The second side of the longitudinal axis E-E is opposite the first side of the longitudinal axis E-E.

Thus, using the inventive transmitting structure 302 of the transducer assembly 300, acoustic waves can be generated in a semiconductor wafer processing system so as to contact the wafer at an angle so that the reflected waves do not come into contact with the transducer assembly 300. This is achieved in the present invention without forming the transducers with rounded or concave bottom surfaces, but rather the bottom surfaces of the transducers are flat and planar. Furthermore, the multiple sets of transducers in a staggered or paired relationship further enhance the ability of the acoustic energy to assist in particle removal from wafer surfaces. Of course, the invention is not to be so limited in all embodiments and in certain other embodiments the transducers can be positioned so as to apply acoustic energy to the surface of the wafer directly from above the wafer at a 90° angle to the wafer surface.

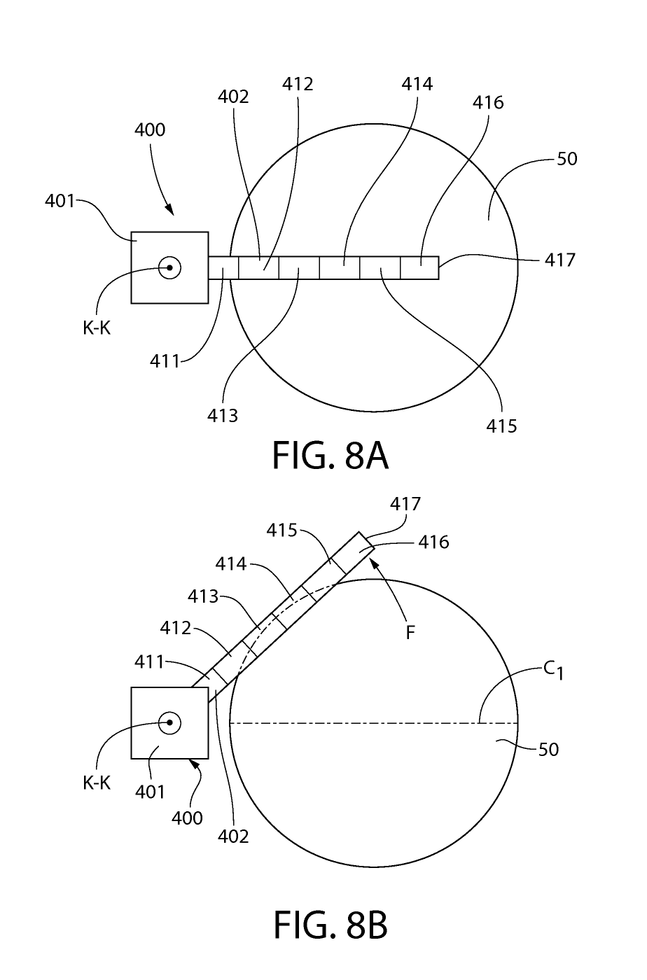

Referring now to FIGS. 8A and 8B concurrently, a schematic overhead view of a transducer assembly 400 and wafer 50 in accordance with another embodiment of the present invention is illustrated. Similar to the earlier described embodiments, the transducer assembly 400 comprises a base 401, a transmitting structure 402 and at least one, or preferably a plurality of transducers. The transducers, which are not illustrated in FIGS. 8A and 8B in order to avoid clutter, can take on any of the arrangements shown in FIGS. 3A, 3B, 3C or 5. Of course, any other arrangement of the transducers can also be used with this embodiment. For example, in FIGS. 8A and 8B, the transmitting structure 402 is illustrated as having six segments or sections including a first section 411, a second section 412, a third section 413, a fourth section 414, a fifth section 415 and a sixth section 416. In one embodiment, an individual transducer (or multiple transducers) may be acoustically coupled to each of the sections 411-416 of the transmitting structure 402. Thus, the transducers may be arranged in a single set of transducers, multiple sets of transducers, transducers that are aligned along an axis, transducers that are positioned in a spaced apart manner, transducers that are staggered on opposing sides of a longitudinal axis or the like.

Regardless of the arrangement of the transducers, in this embodiment it is preferable that the transducers be individually activatable by the controller. Specifically, each transducer should be capable of being powered on and off separately from each of the other transducers. Furthermore, the power level of each transducer should be capable of being changed without changing the power level of any of the other transducers. This can be accomplished via the controller and/or via separately coupling the transducers to their own individual energy sources.

Still referring to FIGS. 8A and 8B concurrently, this embodiment illustrates that the transducer assembly 400, and more specifically the transmitting structure 402 of the transducer assembly 400, is movable relative to the wafer 50. In this particular embodiment, the transmitting structure 402 of the transducer assembly 400 moves in an arcuate or rotational direction relative to the wafer 50, similar to the motion of the tone arm of a vintage record player or to that of a windshield wiper. Thus, as the transmitting structure 402 is made to move relative to the wafer 50, a distal end 417 of the transmitting structure 402 moves in an arcuate pattern from the center of the wafer to the edge of the wafer and vice versa in the direction of the arrow F. The transmitting structure 402 may also be capable of moving in an arcuate pattern from the center of the wafer to the opposite edge of the wafer from that depicted in FIG. 8B. Stated another way, the transmitting structure 402 is capable of a rotational movement about a rotational axis K-K. In the exemplified embodiment, the transmitting structure 402 does not move 360° about the rotational axis K-K, but rather only enough to cover the wafer 50 from edge to edge (i.e., approximately 90° of movement about the rotational axis K-K).

In FIG. 8A, the transducer assembly 400 is illustrated such that the transmitting structure 402 is in a first position. In the first position, each of the sections 411-416 of the transmitting structure 402 is positioned over at least a portion of the wafer 50 such that an axis that is perpendicular to the transmitting structure 402 may intersect each one of the sections 411-416 independently and the wafer 50. Specifically, an axis that is perpendicular to the transmitting structure 402 may intersect the first section 411 and the wafer 50, a different axis that is perpendicular to the transmitting structure 402 may intersect the second section 412 and the wafer 50, a still different axis may intersect the third section 413 and the wafer 50, and so on. When a section is positioned over the wafer 50, the transducer (or transducers) located within that section may be said to be acoustically coupled to the film of liquid that is located between the transducer assembly 400 and the wafer 50. This is because when a particular section is positioned over the wafer 50, the transducer(s) located within that section is able to generate acoustic energy through the film of liquid between the transmitting structure and the wafer 50 to assist in particle removal from the wafer 50.

In FIG. 8B, the transducer assembly 400 is illustrated such that the transmitting structure 402 is in a second position. In the second position, each of the sections 412, 413, 414 and 415 is positioned over at least a portion of the wafer 50 such that an axis may intersect each one of the sections 412-415 and the wafer 50. However, the sections 411 and 415 are not positioned over the wafer 50. In other words, there is no axis perpendicular to the transmitting structure 402 that can be made to intersect the section 411 and the wafer 50 and there is no axis perpendicular to the transmitting structure 402 that can be made to intersect the section 416 and the wafer 50.

When the transducer assembly 400 is in the second position, there is no need for the transducers positioned within the sections 411 and 415 to be generating acoustic energy because the transducers positioned within the sections 411, 415 are acoustically decoupled from the film of liquid. Any acoustic energy generated from the sections 411, 415 while the transducer assembly 400 is in the second position would have no effect on the particle removal from the wafer 50 because the transducers within the sections 411, 415 are not acoustically coupled to the film of liquid between the transmitting structure 402 and the wafer 50. Thus, in the exemplified embodiment, when the transducer assembly 400 is moved into the second position, the transducers that are not acoustically coupled to the film of liquid (i.e., the transducers located within the first section 411 and the sixth section 416 of the transmitting structure 402) will be deactivated (powered off). Thus, when the transducer assembly 400 is in the second position, the transducers located within the first and sixth sections 411, 416 of the transmitting structure 402 will be deactivated and the transducers located within the second, third, fourth and fifth sections 412-415 of the transmitting structure 402 will remain activated (powered on). As the transducer assembly 400 moves back from the second position to the first position, the transducers located within the first and sixth sections 411, 416 of the transmitting structure 4021 may be reactivated as they become acoustically coupled to the film of liquid. By deactivating all transducers that are not acoustically coupled to the film of liquid, burn out of those transducers can be minimized or reduced and the life span of those transducers can be increased.

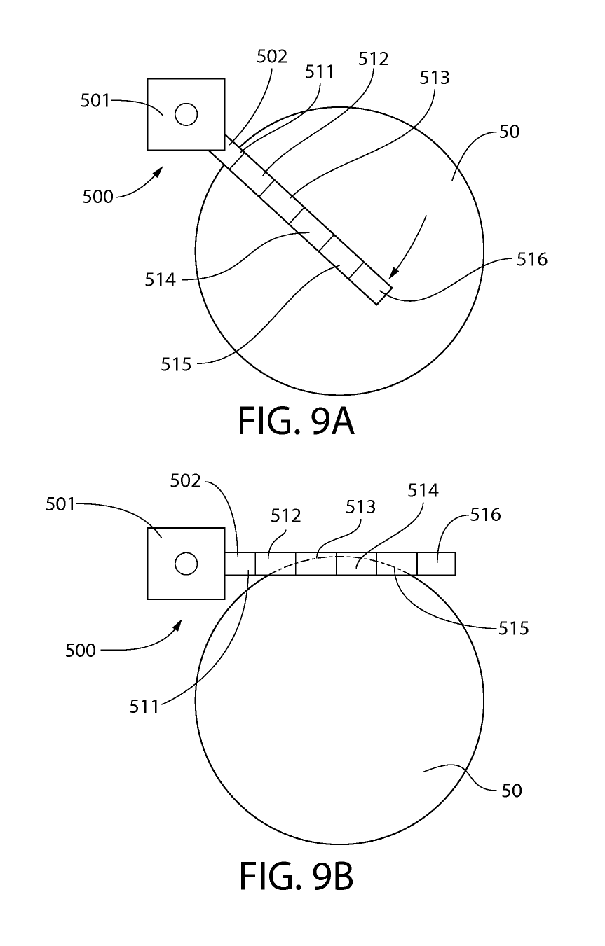

FIGS. 9A and 9B illustrate another embodiment of a transducer assembly 500. The transducer assembly 500 is similar to the transducer assembly 400 and therefore the description of the transducer assembly 500 will focus on the differences therebetween in the interest of brevity. It should be appreciated that the description of the transducer assembly 400 is equally applicable to the transducer assembly 500 for similar features that are similarly numbered (except that 500 series of numbers is used instead of the 400 series of numbers).

In FIG. 9A the transducer assembly 500 is in the first position and in FIG. 9B the transducer assembly 500 is in the second position. In FIGS. 9A-9B, the transducer assembly 500 moves in a rotational or arcuate manner similar to the transducer assembly 400. The only difference is the location of the pivot point or rotational axis of the transducer assemblies 400, 500. In FIGS. 8A, 8B, the pivot point was located along a centerline C₁ of the wafer 50. In FIGS. 9A, 9B, the pivot point is positioned near one edge of the wafer 50 and offset from the centerline C₁. The same effect is achieved with each of the transducer assemblies 400, 500, and thus no further discussion of FIGS. 9A and 9B will be provided.

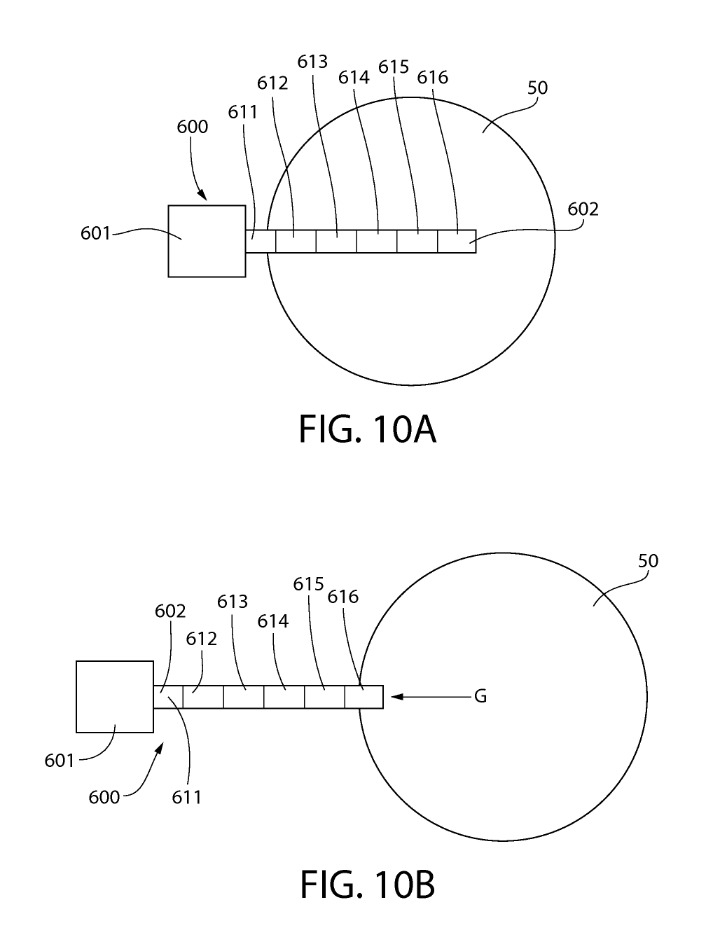

FIGS. 10A and 10B illustrate yet another embodiment of a transducer assembly 600. The transducer assembly 600 is similar to the transducer assemblies 400, 500 and therefore the description of the transducer assembly 600 will focus on the differences therebetween in the interest of brevity. It should be appreciated that the description of the transducer assemblies 400, 500 are equally applicable to the transducer assembly 600 for similar features that are similarly numbered (except that the 600 series of numbers is used instead of the 400 or 500 series of numbers).

The transducer assembly 600 comprises a base 601 and a transmitting structure 602. The transmitting structure comprises a first section 611, a second section 612, a third section 613, a fourth section 614, a fifth section 615 and a sixth section 616. Movement of the transducer assembly 600 is different than movement of the transducer assemblies 400, 500. Specifically, the transducer assembly 600 moves or translates in a linear direction relative to the wafer 500 as indicated by the arrow G. Thus, in FIG. 10A the transducer assembly 600 is in a first position in which each of the sections 611-616 is positioned over a portion of the wafer 50. Thus, in the first position each of the transducers (because each section 611-616 has at least one transducer) is acoustically coupled to the film of liquid. As the transducer assembly 600 moves linearly across the wafer 50 surface in the direction of the arrow G, the transducers in the various sections 611-616 become acoustically decoupled from the film of liquid in succession.

Thus, in this embodiment the transducers can be individually deactivated, such as by the controller, in the order that the transducers become acoustically decoupled from the film of liquid. Specifically, as the transducer assembly 600 moves from the first position to the second position, first the transducer (or transducers) within the first section 611 will become acoustically decoupled from the film of liquid. As the transducer(s) within the first section 611 becomes acoustically decoupled from the film of liquid, those transducer(s) will be deactivated. Next, the transducer(s) within the second section 612 will become acoustically decoupled from the film of liquid as the second section 612 becomes positioned off of the wafer 50. As the transducer(s) within the second section 612 becomes acoustically decoupled from the film of liquid, those transducer(s) will be deactivated. This same process is true for each section 611-616 of the transducer assembly 600. Furthermore, this process is reversed in order to reactivate each of the transducers as they become recoupled with the film of fluid.

In certain embodiments, each of the transducers that is acoustically coupled to the film of liquid will remain activated while each of the transducers that is acoustically decoupled from the film of liquid will be deactivated. In certain embodiments, the transducers are each separately operably coupled to a controller so that the controller can individually and independently deactivate each of the transducers as needed. In some embodiments, the controller automatically deactivates the transducers immediately upon the transducers becoming acoustically decoupled from the film of liquid.

There are several ways that the determination regarding whether to activate or deactivate the transducers can be made. Specifically, in one embodiment the controller can be properly programmed with software to enable the controller to determine when a portion of the transmitting structure that contains one or more transducers is located off of the wafer (i.e., when one of the transducers is no longer acoustically coupled to the film of liquid). In such an embodiment, the controller will make a geometric calculation based on known positions of the transducers and the wafer on a Cartesian coordinate system. Specifically, the X, Y and Z coordinates of the transducers and of the wafer circumference can be known relative to a reference point (such as the point (0, 0) on a Cartesian coordinate system) so that the controller can determine the positioning of the various transducers relative to the wafer. Alternatively, the process recipe may include pre-stored instructions that indicate at what time during the processing procedure each of the various transducers should be activated and deactivated based on the known positioning of those transducers at that particular time. In one such embodiment the process recipe will include instructions regarding the movement of the transducer assembly in terms of direction and speed. Thus based on the direction and speed of movement of the transducer assembly, it can be predetermined when one or more of the transducers will be decoupled from the film of liquid and should therefore be deactivated.

In other embodiments, the transmitting structure may include a liquid sensor at each location of the transmitting structure in which a different transducer is positioned. Each of the liquid sensors can be operably coupled to the controller. Thus, when the sensor senses liquid, it will transmit a signal to the controller indicating that the transducer associated with that particular sensor should be activated. When the sensor does not sense liquid, it will transmit a signal to the controller indicating that the transducer associated with that particular sensor should be deactivated. In other embodiments, the sensor may be a temperature sensor to measure the temperature at the location of each of the transducers. The liquid will have a known temperature so that if the transducer is acoustically coupled to the film of liquid, it will have a temperature similar to the temperature of the film of liquid. When the transducer is not acoustically coupled to the film of liquid, the temperature at the location of that transducer will change and the controller will then know to deactivate that particular transducer. Of course, the invention is not to be limited in all embodiments by the particular manner in which the controller determines whether a particular transducer is acoustically coupled to the film of liquid or not, and other possibilities are within the scope of this invention.

In one embodiment, the invention can be directed to a method of processing a wafer. The method may include positioning the wafer on a support and rotating the wafer. After the wafer is rotating, a liquid may be dispensed on a first surface of the wafer. Next, a transducer assembly may be positioned adjacent to the first surface of the flat article so that a film of liquid is formed between a transmitting structure of the transducer assembly and the first surface of the flat article. The transducer assembly may comprise a plurality of transducers that are acoustically coupled to the transmitting structure. Each of the plurality of transducers may be individually activatable. The method then includes moving the transducer assembly relative to the flat article between: (1) a first position in which each of the plurality of transducers is acoustically coupled to the film of liquid; and (2) a second position in which at least one of the plurality of transducers is acoustically decoupled from the film of liquid. Finally, when one of the plurality of transducers becomes acoustically decoupled from the film of liquid the method includes deactivating the decoupled transducer. Deactivation may be accomplished manually by a user or operator or automatically by a controller as has been described herein above.

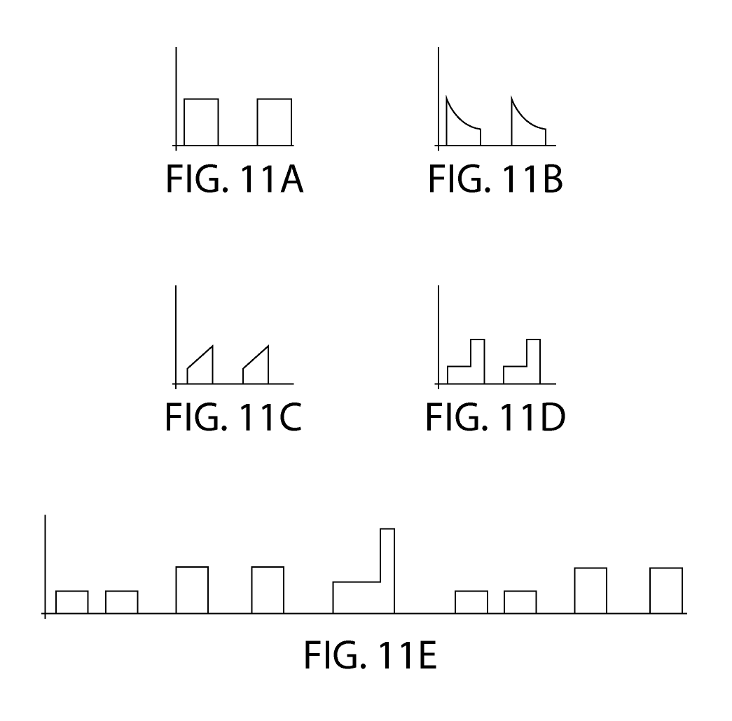

Referring now to FIGS. 11A-11E, power control of the transducers will be discussed in accordance with an embodiment of the present invention. It is known in the art that applying acoustic energy to a liquid causes cavitation in the liquid from the oscillation of the liquid. The cavitation causes small micro bubbles to form in the liquid, and the longer the bubbles survive, the larger the bubbles become and the more energy they release when they finally fail and implode. If the bubbles release too much energy upon imploding, they can cause damage to the surfaces of the wafer. Therefore, in one embodiment of the present invention, the transducers are activated in a pulse mode such that the transducers are pulsed on and off repeatedly. The on time allows for bubbles to be created in the liquid and in some cases to implode. The off time relaxes the solution allowing the bubbles to shrink and gas to go back into the solution.

Different variations of the pulse control are illustrated graphically in FIGS. 11A through 11E. In FIG. 11A, the transducers are pulsed at a fixed power level for a predetermined short period of time (i.e., less than one second at a frequency between 400 KHz and 5 MHz). After the period of time has expired, the transducers are then powered off for a short period of time, and then this on/off pulsing of the transducers is repeated. This pulsing sequence may prevent implosion of the formed bubbles so as to prevent damage to the wafers from such implosions. Rather, the bubbles may form and grow during the “on” periods and then shrink during the “off” periods.

In FIG. 11B, the transducers are decreased in power level during the on time. Thus, each pulse starts with a high power level and then gradually decreases to a lower power level before the end of the pulse, and this is repeated. Higher power levels during the beginning of the powered on time allow for faster bubble creation and lower power levels at the end of a pule maintains the bubble sizes while in certain instances preventing or reducing bubble implosion. In FIG. 11C, the power level of the transducers is increased during the on time of each pulse. Thus, each pulse starts with a low power level and then gradually increases to a higher power level before the end of the pulse, and this is repeated.

In FIG. 11D, the power level is varied during the on time of each pulse. Specifically, the initial power level may be a lower power level to create a bubble having a particular size, and then an increased or stepped up power level (i.e., higher power level) may force bubble failure or implosion. Thus, the frequency of power level at the end of the pulse can be selected to force bubble failure or implosion for a desired result. In FIG. 11E, the power levels are adjusted in successive pulses rather than within a single pulse. Thus, a first pulse may have a first power level, a second pulse may have a second power level, and a third pulse may have a varied or stepped up power level. This type of pulsing allows for a long time system pattern to be developed to achieve bubble creation and control over longer periods of time (as compared to the period of time of a single pulse). Frequency and power may be adjusted as desired to control bubble size and bubble cavitation/failure.

The gas types and concentration may impact the desired pulse time, power levels, etc. Gasses that are readily dissolved into solution such as CO2 may use one set of on/off pulse time controls or combinations while a less soluble gas such as Nitrogen or Argon may use a different set of on/off pulse time controls or combinations.

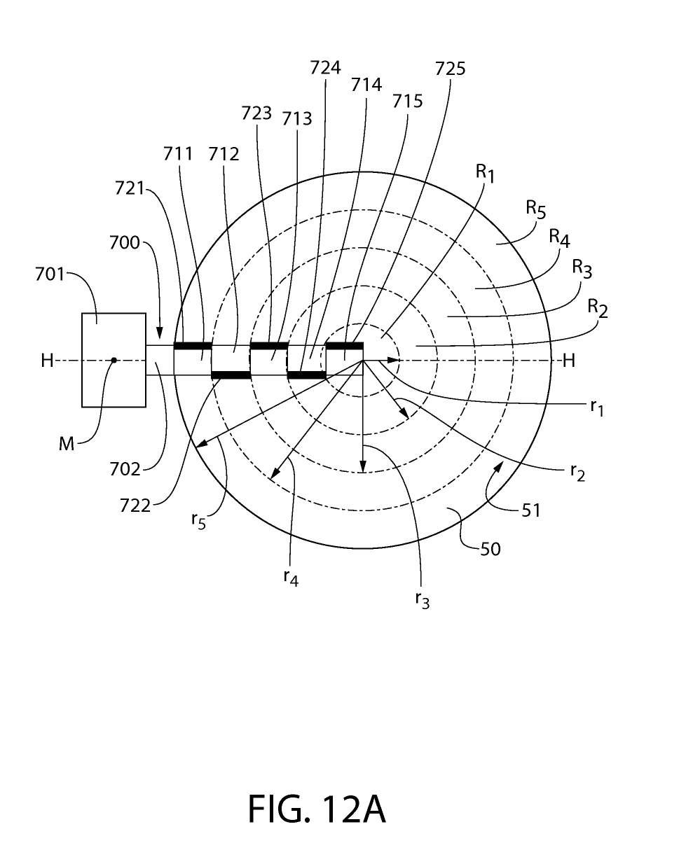

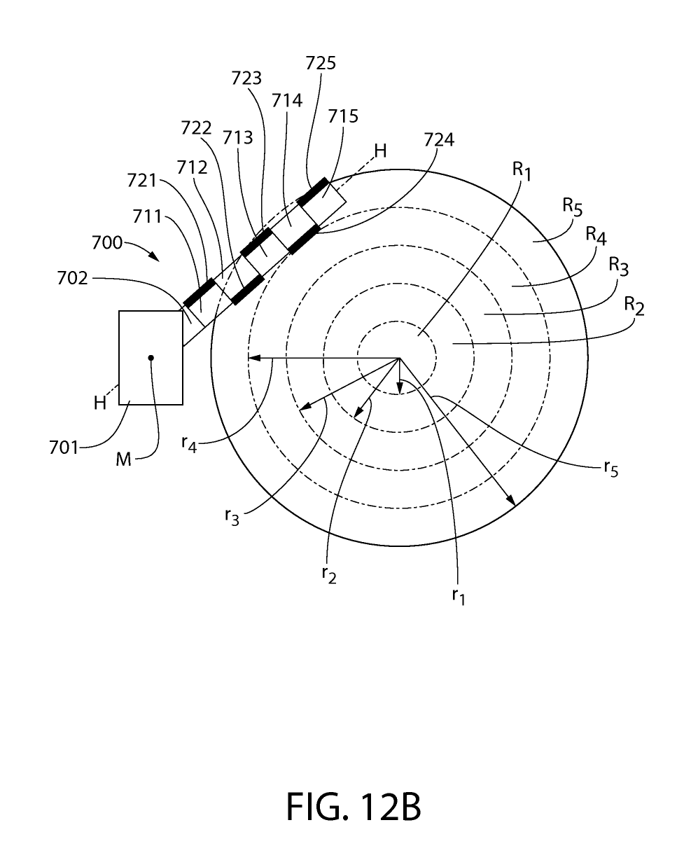

Referring now to FIGS. 12A and 12B concurrently, another aspect of the invention will be described. FIGS. 12A and 12B illustrate a transducer assembly 700 comprising a base 701 and a transmitting structure 702 extending from the base in a cantilevered manner. The transmitting structure 702 is positioned over a wafer 50 for processing and for application of acoustic energy to the first surface 51 of the wafer 50. Although not illustrated, as discussed in detail above a film of liquid is formed between the transmitting structure 702 and the first surface 51 of the wafer 50 so that acoustic energy generated by the transmitting structure 702 (specifically by the transducers) can be generated through the film of liquid.

In the exemplified embodiment, the transmitting structure 702 is an elongated rod-like structure that extends along a longitudinal axis H-H. Of course, the invention is not to be so limited in all embodiments and the transmitting structure 702 can take on any other shape, including any shape discussed or disclosed herein (i.e., triangular, pie-shaped, rectangular shaped, square shaped, circular shaped, etc.). The transmitting structure 702 is conceptually divided into a plurality of sections including a first section 711, a second section 712, a third section 713, a fourth section 714 and a fifth section 715. In the exemplified embodiment, the sections 711-715 are longitudinal sections in that each section 711-715 forms a longitudinal portion or segment of the transmitting structure 702.

In the exemplified embodiment, a single transducer is acoustically coupled to the transmitting structure 702 within each of the sections 711-715 of the transmitting structure 702. More specifically, a first transducer 721 is acoustically coupled to the transmitting structure 702 and is located within the first section 711 of the transmitting structure 702, a second transducer 722 is acoustically coupled to the transmitting structure 702 and is located within the second section 712 of the transmitting structure 702, a third transducer 723 is acoustically coupled to the transmitting structure 702 and is located within the third section 713 of the transmitting structure 702, a fourth transducer 724 is acoustically coupled to the transmitting structure 702 and is located within the fourth section 714 of the transmitting structure 702, and a fifth transducer 725 is acoustically coupled to the transmitting structure 702 and is located within the fifth section 715 of the transmitting structure 702. Although five transducers and five sections are depicted in the drawings, more or less than five transducers and five sections can be used in other embodiments as desired.

In the exemplified embodiment, the arrangement and positioning of the transducers 721-725 is similar to that depicted in FIG. 3A which has been described above. Specifically, the first transducer 721, the third transducer 723 and the fifth transducer 725 are positioned on a first side of the longitudinal axis H-H and arranged in a longitudinally spaced apart manner and the second transducer 723 and the fourth transducer 724 are positioned on a second side of the longitudinal axis H-H and arranged in a longitudinal spaced apart manner, the second side of the longitudinal axis H-H being opposite the first side. Thus, the first, third and fifth transducers 721, 723, 725 form a first set of transducers and the second and fourth transducers 722, 724 form a second set of transducers. Furthermore, the first, third and fifth transducers 721, 723, 725 and the second and fourth transducers 722, 724 are positioned in a staggered arrangement along the longitudinal axis H-H. In the exemplified embodiment, the first, third and fifth transducers 721, 723, 725 are aligned along a longitudinal axis that is parallel to the longitudinal axis H-H and the second and fourth transducers 722, 724 are aligned along a longitudinal axis that is parallel to the longitudinal axis H-H.

However, the invention is not to be limited by the arrangement depicted in FIGS. 12A and 12B in all embodiments. Thus, in some embodiments the transducers 721-725 may be arranged similar to that depicted in FIG. 3B (staggered with overlap) or similar to that depicted in FIG. 3C (not staggered but arranged in pairs). In the exemplified embodiment, each section 711-715 of the transmitting structure 702 includes only one transducer 721-725. However, the invention is not to be so limited and in certain embodiments each section 711-715 of the transmitting structure 702 may include two or more transducers, or some of the sections 711-715 may include two or more transducers while others of the sections 711-715 include only one transducer. In one particular embodiment, each section 711-715 may include one transducer on each side of the longitudinal axis H-H. The transducers 721-725 may be oriented at an acute angle relative to the first surface 51 of the wafer 50 as discussed with reference to FIGS. 4-7, or they may be oriented perpendicularly to the first surface 51 of the wafer 50.

Still referring to FIGS. 12A and 12B, the wafer or flat article 50 is depicted having or being divided into a plurality of reference rings R₁, R₂, R₃, R₄ and R₅. The boundaries between adjacent ones of the reference rings R₁, R₂, R₃, R₄ and R₅ are illustrated as a dotted line. The reference rings include a first reference ring R₁ having a first radius r₁, a second reference ring R₂ having a second radius r₂, a third reference ring R₃ having a third radius r₃, a fourth reference ring R₄ having a fourth radius r₄ and a fifth reference ring R₅ having a fifth radius r₅. The fifth radius r₅ is greater than the fourth radius r₄, the fourth radius r₄ is greater than the third radius r₃, the third radius r₃ is greater than the second radius r₂ and the second radius r₂ is greater than the first radius r₁. Thus, the first reference ring R₁ has the smallest radius r₁ and the fifth reference ring R₅ has the greatest or largest radius r₅. The radiuses r₁-r₅ are denoted in the drawings as the outer radius of each ring R₁-R₅, it being understood that each ring has an outer radius and an inner radius. Although five reference rings are illustrated in the figures, the wafer can be divided into more or less reference rings in other embodiments as desired. Each reference ring R₁-R₅ encompasses an annular section of the wafer 50 and the reference rings R₁-R₅ are concentric.

In FIG. 12A the transducer assembly 700 is depicted in a first position and in FIG. 12B the transducer assembly 700 is depicted in a second position. The transducer assembly 700 may be coupled to an actuator and a controller in order to enable movement of the transducer assembly 700 as has been discussed in detail above. In the exemplified embodiment when the transducer assembly 700 is in the first position, one of the sections 711-715 of the transmitting structure 702 is positioned within each reference ring R₁-R₅. Specifically, the first section 711 of the transmitting structure 702 is positioned within the fifth reference ring R₅, the second section 712 of the transmitting structure 702 is positioned within the fourth reference ring R₄, the third section 713 of the transmitting structure 702 is positioned within the third reference ring R₃ the fourth section 714 of the transmitting structure 702 is positioned within the second reference ring R₂, and the fifth section 715 of the transmitting structure 702 is positioned within the first reference ring R₁. By being positioned within a reference ring, what is meant is that the relative section of the transmitting structure 702 is positioned within the bounds of the reference ring between the inner and outer surfaces of the reference ring although that section of the transmitting structure 702 may actually be located above or below the wafer surface (above in the exemplified embodiment).

Due to the positioning of the transmitting structure 702 relative to the wafer 50 in the first position, each reference ring R₁-R₅ has at least one transducer applying acoustical energy thereto. Specifically the first transducer 721 is applying acoustical energy to the fifth reference ring R₅, the second transducer 722 is applying acoustical energy to the fourth reference ring R₄, the third transducer 723 is applying acoustical energy to the third reference ring R₃, the fourth transducer 724 is applying acoustical energy to the second reference ring R₂ and the fifth transducer 725 is applying acoustical energy to the first reference ring R₁. Thus, in the first position each reference ring is receiving the same amount of acoustical energy. However, because there is more surface area in the fifth reference ring R₅ than there is in the first reference ring R₁, each portion of the surface of the wafer 50 within the first reference ring R₁ is receiving more acoustical energy than each portion of the surface of the wafer 50 within the fifth reference ring R₅. Stated another way, during processing the wafer 50 is rotated and the portion of the wafer 50 within the fifth reference ring R₅ is moving faster than the portion of the wafer 50 within the first reference ring R₁ (and each of the other reference rings R₂-R₄), and thus the surface within the fifth reference ring R₅ is subjected to the acoustic energy for less time than in each of the other reference rings R₁-R₄.

In FIG. 12B, the transducer assembly 700 is illustrated in a second position. The transducer assembly 700 in this embodiment moves in an arcuate or rotational direction about a rotation axis or pivot point M. When in the second position, at least two of the sections 711-715 of the transmitting structure 702 are positioned within the fifth reference ring R₅ (i.e., the reference ring having the largest radius). More specifically, in the second position portions of each of the first through fifth 711-715 sections of the transmitting structure 702 are positioned within the fifth reference ring R₅ and none of the sections of the transmitting structure 702 are positioned with any of the other reference rings R₁-R₄. Thus, in the second position the first through fifth transducers 721-725 may be applying acoustic energy to the fifth reference ring R₅ of the wafer 50 and none of the transducers will be applying acoustic energy to any of the other reference rings R₁-R₄.

Although in FIG. 12B the second, third and fourth transducers 722-724 are positioned within the fifth reference ring R₅, in certain embodiments all of the transducers 721-725 may be positioned within the fifth reference ring R₅ or any number of the transducers may be positioned within the fifth reference ring R₅. In certain embodiments, it is merely preferred that in the second position multiple transducers are applying acoustic energy to the regions of the wafer 50 within the fifth reference ring R₅ while none of the transducers are applying acoustic energy to any of the other reference rings R₁-R₄.

In this embodiment, all of the transducers 721-725 may be individually activatable as has been discussed in more detail above. In that regard, when one of the sections 711-715 is positioned off of the wafer 50, the transducer 721-725 within that section may be deactivated to prevent burnout of the transducers. Furthermore, by having multiple ones of the transducers 721-725 apply acoustic energy to the fifth reference ring R₅ when the transducer assembly 700 is in the second position, uniformity can be achieved in the application of acoustic energy because as noted previously when the transducer assembly 700 is in the first position the fifth reference ring R₅ receives less acoustic energy than the other reference rings R₁-R₄. Furthermore, the transducer assembly 700 can be rotated at a speed that ensures that each reference ring R₁-R₅ of the wafer 50 receives the same amount of acoustic energy during a wafer processing session.

Various modifications to the above disclosed systems, apparatus and methods are possible. In one variation, the transmitting structure or transducer assembly can include water or chemical fluids or be fluidly coupled to a water or chemical fluid source. In that regard, the transmitting structure may operate as a water or fluid dispenser in addition to an acoustic energy transmitter. This will facilitate the providing of a wet area (i.e. meniscus) to assist in the transport of acoustical energy to the wafer. Specifically because the transmitting structure will actually be dispensing the water or chemical fluids, it will be ensured that the water or chemical fluids form a meniscus between the transmitting structure and the wafer. This can be done as an alternative to the dispensers discussed above. The transducer assembly or transmitting structure can also include water or chemical fluids to provide flushing. Specifically, the acoustic energy transmitted by the transducer assembly provides cleaning effects on the wafer, and the acoustic energy also provides near wafer streaming effects by moving the particles and contamination away from the surface. The additional fluid dispensed from the transmitting structure or transducer assembly may provide additional streaming effects to sweep the removed particles away from the cleaned areas. One example of fluid dispensing from the transmitting structure is disclosed in United States Patent Application Publication No. 2011/0041871, filed on Oct. 5, 2010, the entirety of which is incorporated herein by reference.

In another embodiment, the transducer can be made of various frequency pillar elements. One example of the pillar element arrangement is disclosed in U.S. Pat. No. 8,279,712, the entirety of which is incorporated herein by reference. Various frequency pillar elements will enable the transducer to operate at multiple frequencies. Specifically, lower frequencies can be used for larger or stubborn particle removal and higher frequencies can be used for small particle removal or for fine/soft cleaning and micro streaming to prevent damage to the wafer surfaces. Multiple transducers can be used, each at a different frequency, if so desired.

Various combinations of the teachings of the various embodiments disclosed herein are within the scope of the present invention. Thus, for example, the various movements of the transducer assembly disclosed herein can be incorporated into any of the embodiments even if movement is not disclosed with regard to that particular embodiment. Furthermore, the activation and deactivation of the transducers can also be incorporated into any of the embodiments disclosed herein. Thus, the invention in some embodiments may be the result of a combination of different aspects of the different embodiments disclosed herein. In some embodiments the invention can be the entire cleaning system described herein, in other embodiments the invention can be a method of cleaning a flat article utilizing the system described herein, and in still other embodiments the invention can be the transducer assembly alone without the remaining components.

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. A system for processing flat articles comprising:
a support for supporting a flat article;
a dispenser for applying liquid to a first surface of the flat article on the support;
a transducer assembly comprising:
a transmitting structure having a longitudinal axis;
a first set of transducers for generating acoustic energy, the first set of transducers acoustically coupled to the transmitting structure in a spaced apart manner on a first side of the longitudinal axis;
a second set of transducers for generating acoustic energy, the second set of transducers acoustically coupled to the transmitting structure in a spaced apart manner on a second side of the longitudinal axis;
the transducers of the first and second sets staggered along the longitudinal axis; and
the transducer assembly positioned so that when the dispenser applies liquid to the first surface of the flat article on the support, a film of liquid is formed between the transmitting structure and the first surface of the flat article.

2. The system of claim 1 wherein the first set of transducers are aligned along a first axis that is substantially parallel to the longitudinal axis and wherein the second set of transducers are aligned along a second axis that is substantially parallel to the longitudinal axis.

3. The system of claim 1 wherein no plane that is transverse to the longitudinal axis intersects one of the transducers of the first set of transducers and one of the transducers of the second set of transducers.

4. The system of claim 3 wherein each transducer of the first set of transducers is transversely aligned with a gap between adjacent transducers of the second set of transducers and wherein each transducer of the second set of transducers is transversely aligned with a gap between adjacent transducers of the first set of transducers such that there is no overlap between the transducers of the first set of transducers and the transducers of the second set of transducers.

5. The system of claim 1 wherein a plane that is transverse to the longitudinal axis intersects at least one transducer of the first set of transducers and at least one transducer of the second set of transducers.

6. The system of claim 1 wherein each transducer of the first set of transducers is transversely aligned with a gap between adjacent transducers of the second set of transducers and with a portion of at least one transducer of the second set of transducers and wherein each transducer of the second set of transducers is transversely aligned with a gap between adjacent transducers of the first set of transducers and with a portion of at least one transducer of the first set of transducers such that the transducers of the first set of transducers and the transducers of the second set of transducers overlap.

7. The system of claim 1 wherein each transducer of the first set of transducers has a first section, a second section and a third section, wherein the first section of the transducers of the first set of transducers are transversely aligned with a first transducer of the second set of transducers, the third section of the transducers of the first set of transducers are transversely aligned with a second transducer of the second set of transducers, and the second section of the transducers of the first set of transducers are transversely aligned with a gap located between the first and second transducers of the second set of transducers.

8. The system of claim 7 wherein the second section of the transducers of the first set of transducers is located between the first and third sections of the transducers of the first set of transducers.

9. The system of claim 1 wherein each transducer of the first set of transducers and each transducer of the second set of transducers is separately controllable with regard to power level and activation status.

10. The system of claim 1 wherein each transducer of the first set of transducers and each transducer of the second set of transducers is individually activatable.

11. The system of claim 10 further comprising:
an actuator operably coupled to the transducer assembly;
a controller operably coupled to the actuator and configured to move the transducer assembly relative to the flat article between: (1) a first position in which each of the transducers of the first and second sets of transducers is acoustically coupled to the film of liquid; and (2) a second position in which at least one of the transducers of the first and second sets of transducers is acoustically decoupled from the film of liquid; and
wherein in the second position the at least one of the transducers is deactivated.

12. The system of claim 1 wherein the transmitting structure is an elongated tubular structure having an outer surface and an inner surface, and wherein the first and second sets of transducers are acoustically coupled to the inner surface.

13. The system of claim 12 wherein the inner surface of the elongated tubular structure comprises a first planar section and a second planar section, the first and second planar sections arranged at a non-zero angle relative to one another, and wherein the first set of transducers are acoustically coupled to the first planar section and the second set of transducers are acoustically coupled to the second planar section.

14. The system of claim 13 wherein the first set of transducers are configured to generate acoustic energy at a first non-normal angle relative to the surface of the flat article that results in reflected acoustic waves traveling away from the transducer assembly and wherein the second set of transducers are configured to generate acoustic energy at a second non-normal angle relative to the surface of the flat article that results in reflected acoustic waves traveling away from the transducer assembly.

15. The system of claim 14 wherein the first set of transducers generate acoustic energy towards the first surface of the flat article on the first side of the longitudinal axis and wherein the second set of transducers generate acoustic energy towards the first surface of the flat article on the second side of the longitudinal axis.

16. The system of claim 1 wherein the support is a rotatable support that supports and rotates the flat article in a substantially horizontal orientation.

17. The system of claim 1 further comprising an actuator operably coupled to the transducer assembly, the actuator configured to move the transducer assembly in an arcuate or rotational direction.

18. An apparatus for generating acoustic energy comprising:
a transmitting structure having a longitudinal axis;
a first set of transducers for generating acoustic energy, the first set of transducers acoustically coupled to the transmitting structure on a first side of the longitudinal axis in a spaced apart manner;
a second set of transducers for generating acoustic energy, the second set of transducers acoustically coupled to the transmitting structure on a second side of the longitudinal axis in a spaced apart manner; and
the transducers of the first and second sets staggered along the longitudinal axis.

19. A system for processing flat articles comprising:
a support for supporting a flat article;
a dispenser for applying liquid to a first surface of the flat article on the support;
a transducer assembly comprising:
a transmitting structure having a longitudinal axis;
a first set of transducers for generating acoustic energy, the first set of transducers acoustically coupled to the transmitting structure on a first side of the longitudinal axis in a spaced apart manner;
a second set of transducers for generating acoustic energy, the second set of transducers acoustically coupled to the transmitting structure on a second side of the longitudinal axis in a spaced apart manner;
the first and second sets of transducers arranged in pairs along the longitudinal axis so that each transducer of the first set of transducers is transversely aligned with one of the transducers of the second set of transducers; and
the transducer assembly positioned so that when the dispenser applies liquid to the first surface of the flat article on the support, a film of liquid is formed between the transmitting structure and the first surface of the flat article.

20-59. (canceled)

60. The apparatus of claim 18 wherein the first set of transducers are aligned along a first axis that is substantially parallel to the longitudinal axis and wherein the second set of transducers are aligned along a second axis that is substantially parallel to the longitudinal axis.
